(19) United States
(12) Patent Application Publication
(10) Pub. No.: US 2021/0240918 A1
(43) Pub. Date: Aug. 5, 2021

(54) INPUT DEVICE, INPUT METHOD, AND INPUT SYSTEM

(71) Applicant: Panasonic Intellectual Property Management Co., Ltd., Osaka (JP)

(72) Inventors: Kenji TACHIBANA, Osaka (JP); Taishi ASANO, Osaka (JP); Shunsuke SAITO, Osaka (JP); Masashi SETO, Osaka (JP); Masaharu HIROHATA, Osaka (JP)

(21) Appl. No.: 17/220,113

(22) Filed: Apr. 1, 2021

Related U.S. Application Data
(63) Continuation of application No. PCT/JP2019/038287, filed on Sep. 27, 2019.
(60) Provisional application No. 62/740,677, filed on Oct. 3, 2018.

(51) Int. Cl. G06F 40/166; G06K 9/03; G10L 15/22; G10L 15/10

(52) U.S. Cl. CPC G06F 40/166; G06K 9/033; G06K 2209/15; G10L 15/10; G06K 2209/01; G10L 15/22

(57) ABSTRACT

The present disclosure provides an input device mounted on a moving body, comprising: an input unit that accepts input information containing character strings and correction information containing one or more characters; a degree-of-similarity calculation unit that edits character strings of the input information using the one or more characters of the correction information, to calculate degrees of similarity between character strings of the input information before and after editing; and a correction processing unit that corrects a character string of the input information based on the degrees of similarity calculated by the degree-of-similarity calculation unit.

### CROSS-REFERENCE TO RELATED APPLICATIONS

This is a continuation application of International Application No. PCT/JP2019/038287, with an international filing date of Sep. 27, 2019, which claims priority of U.S. Provisional Application No. 62/740,677 filed on Oct. 3, 2018, the content of which is incorporated herein by reference.

### BACKGROUND OF THE INVENTION

### 1. Field of the Invention

The present disclosure relates to an input device, an input method, and an input system.

### 2. Description of the Related Art

JP1992-101286A discloses a license plate information reading device that captures a scene image containing license plates of vehicles to detect a license plate area from the captured scene image, to thereby read character information written on the license plate.

### SUMMARY OF THE INVENTION

An object of the present disclosure is to provide an input device, an input method, and an input system capable of easily correcting input information.

The input device of an aspect of the present disclosure is an input device mounted on a moving body, comprising:

an input unit that accepts input information containing character strings and correction information containing one or more characters;

a degree-of-similarity calculation unit that edits character strings of the input information using the one or more characters of the correction information, to calculate degrees of similarity between character strings of the input information before and after editing; and

a correction processing unit that corrects a character string of the input information based on the degrees of similarity calculated by the degree-of-similarity calculation unit.

The input method of an aspect of the present disclosure is an input method which is performed on a moving body, comprising:

accepting input information containing character strings;

accepting correction information containing one or more characters;

editing character strings of the input information using the one or more characters of the correction information, to calculate degrees of similarity between character strings of the input information before and after editing; and correcting a character string of the input information based on the degrees of similarity calculated.

The input system of an aspect of the present disclosure is an input system comprising:

an arithmetic processing device mounted on a moving body; and

a server communicating with the arithmetic processing device via a network,

the arithmetic processing device comprising:

an input unit that accepts input information containing character strings and correction information containing one or more characters; and

a first communication unit communicating with the server via the network,

the server comprising:

a second communication unit communicating with the arithmetic processing device via the network;

a degree-of-similarity calculation unit that edits character strings of the input information using the one or more characters of the correction information, to calculate degrees of similarity between character strings of the input information; and

a correction processing unit that corrects a character string of the input information based on the degrees of similarity calculated by the degree-of-similarity calculation unit.

According to the present disclosure, there can be provided the input device, the input method, and the input system allowing easy correction of input information.

### BRIEF DESCRIPTION OF THE DRAWINGS

FIG. 1 is a block diagram showing an example of the configuration of an input device of a first embodiment according to the present disclosure;

FIG. 2 is a schematic view showing an example of input information;

FIG. 3 is a schematic view showing an example of correction of the input information;

FIG. 4A is a schematic view explaining an example of calculation of a degree of similarity between character strings;

FIG. 4B is a schematic view explaining an example of calculation of the degree of similarity between character strings;

FIG. 5A is a schematic view showing an example of calculation of a distance;

FIG. 5B is a schematic view showing an example of calculation of the distance;

FIG. 6 is a schematic view showing another example of calculation of the distance;

FIG. 7 is a schematic view showing another example of calculation of the distance;

FIG. 8 is a flowchart showing an example of an input method of the first embodiment according to the present disclosure;

FIG. 9 is a schematic view showing another example of correction of the input information;

FIG. 10 is a schematic view showing another example of correction of the input information;

FIG. 11 is a block diagram showing an example of the configuration of an input device of a second embodiment according to the present disclosure;

FIG. 12 is a flowchart showing an example of an input method of the second embodiment according to the present disclosure;

FIG. 13A is a schematic view explaining an example of acquisition of input information;

FIG. 13B is a schematic view explaining an example of acquisition of the input information;

FIG. 13C is a schematic view explaining an example of acquisition of the input information;

FIG. 13D is a schematic view explaining an example of acquisition of the input information;

FIG. 14A is a schematic view explaining another example of acquisition of the input information;

FIG. 14B is a schematic view explaining another example of acquisition of the input information;

FIG. 14C is a schematic view explaining another example of acquisition of the input information;

FIG. 15A is a schematic view explaining still another example of acquisition of the input information;

FIG. 15B is a schematic view explaining still another example of acquisition of the input information;

FIG. 16A is a schematic view explaining yet another example of acquisition of the input information;

FIG. 16B is a schematic view explaining yet another example of acquisition of the input information;

FIG. 16C is a schematic view explaining yet another example of acquisition of the input information;

FIG. 16D is a schematic view explaining yet another example of acquisition of the input information;

FIG. 17 is a block diagram showing an example of the configuration of an input device of a third embodiment according to the present disclosure;

FIG. 18 is a schematic view explaining an example of acquisition of input information;

FIG. 19 is a block diagram showing an example of the configuration of an input system of a fourth embodiment according to the present disclosure; and

FIG. 20 is a flowchart showing an example of an input method of the fourth embodiment according to the present disclosure.

### DESCRIPTION OF THE PREFERRED EMBODIMENTS

(Circumstances Leading to this Disclosure)

In the reading device described in JP1992-101286A, character information may be incorrectly read. In such a case, the user performs a work of correcting the character information. For example, the user operates a touch panel or the like with a finger to correct the character information. Alternatively, the user corrects the character information by voice input.

Such a reading device may be mounted on police vehicles such as police cars. For example, the user reads the character information of the license plate of an automobile traveling in front of a police vehicle by the reading device. The user uses the character information read by the reading device as input information, to collate the number of the automobile with a database or the like. At this time, if the reading device erroneously reads the character information, the user performs the work of correcting the input information.

Further, as an input form other than use of the reading device, input information may be input by voice input. The police vehicles are in an environment where noise is more likely to occur than in general vehicles. Therefore, when input information is input by voice input, the input information is likely to be erroneously recognized due to noise. For this reason, the number of times of correction of the input information may be larger than that of general vehicles.

When the user is driving, however, it is difficult to correct the input information. Police vehicles therefore require easy correction of the input information. Police vehicles may also require urgency, so that rapid and smooth correction of the input information is required.

It is required even in a moving body such as a general vehicle that the input information be easily corrected. For example, in the car navigation system of a general vehicle, the input information may be erroneously recognized when the destination address, etc. is input by voice input. Also in such a case, easy correction of the input information is required.

Thus, the inventors have diligently studied to solve these problems, and finally have found calculating the degrees of similarity based on the input information and correction information to thereby correct the input information based on the degrees of similarity, leading to the following disclosure.

An input device of a first aspect of the present disclosure is an input device mounted on a moving body, comprising:

an input unit that accepts input information containing character strings and correction information containing one or more characters;

a degree-of-similarity calculation unit that edits character strings of the input information using the one or more characters of the correction information, to calculate degrees of similarity between character strings of the input information before and after editing; and

a correction processing unit that corrects a character string of the input information based on the degrees of similarity calculated by the degree-of-similarity calculation unit.

With such a configuration, the input information can be corrected easily.

In the input device of a second aspect of the present disclosure,

the degree-of-similarity calculation unit may comprise a distance calculation unit that edits character strings of the input information using the one or more characters of the correction information, to calculate distances between character strings of the input information before and after editing, and

the correction processing unit may correct a character string of the input information based on the distances between character strings calculated by the distance calculation unit.

With such a configuration, the input information can be corrected more easily.

In the input device of a third aspect of the present disclosure,

the distance calculation unit may carry out at least any one of editing processes of insert, delete, and replace on character strings of the input information, to thereby calculate distances between character strings of the input information before and after editing.

With such a configuration, the input information can be corrected more easily.

In the input device of a fourth aspect of the present disclosure,

the correction processing unit may correct a character string of the input information of a portion having a smallest distance among the distances between character strings calculated by the distance calculation unit.

With such a configuration, the input information can be corrected more accurately.

In the input device of a fifth aspect of the present disclosure,

the input information may have a plurality of attributes for classifying a plurality of character strings of the input information,

the degree-of-similarity calculation unit may comprise an attribute determination unit that determines into which attribute among the plurality of attributes the correction information is classified, and

the degree-of-similarity calculation unit may calculate the degrees of similarity based on the attributes of the input information and of the input information.

With such a configuration, the input information can be corrected more rapidly.

In the input device of a sixth aspect of the present disclosure,

the correction processing unit may correct a character of a portion having a highest degree of similarity in the character strings of the input information with the same attribute between the input information and the correction information.

With such a configuration, the input information can be corrected more accurately.

In the input device of a seventh aspect of the present disclosure,

if in the character strings of the input information there exist a plurality of portions having a highest degree of similarity among a plurality of degrees of similarity calculated by the degree-of-similarity calculation unit, the correction processing unit may correct a character of a first-calculated portion having a highest degree of similarity.

With such a configuration, the input information can be corrected more rapidly and more accurately.

The input device of an eighth aspect of the present disclosure may further comprise:

a display that displays the input information and the input information corrected.

With such a configuration, the input information can be displayed.

In the input device of a ninth aspect of the present disclosure,

the input unit may comprise a voice input unit that accepts voice information indicative of the input information and voice information indicative of the correction information,

the input device may further comprise:

a determination unit that determines whether the voice information accepted by the voice input unit is the input information or the correction information, and

if the determination unit determines that the voice information is the correction information, the degree-of-similarity calculation unit may calculate the degrees of similarity.

With such a configuration, input and correction of information can be performed easily by voice input.

In the input device of a tenth aspect of the present disclosure,

the input information may include image information having a character string captured,

the correction information may include voice information containing information of one or more characters,

the input unit may comprise an image acquisition unit acquiring the image information and a voice input unit accepting the voice information, and

the input device may further comprise:

a first conversion unit that converts character string information contained in the image information acquired by the image acquisition unit, into text information; and

a second conversion unit that converts information of one or more characters contained in the voice information accepted by the voice input unit, into text information.

With such a configuration, the input information acquired from the image information can be corrected easily by voice input.

An input method of an eleventh aspect of the present disclosure is an input method which is performed on a moving body, comprising:

accepting input information containing character strings;

accepting correction information containing one or more characters;

editing character strings of the input information using the one or more characters of the correction information, to calculate degrees of similarity between character strings of the input information before and after editing; and correcting a character string of the input information based on the degrees of similarity calculated.

With such a configuration, the input information can be corrected easily.

An input system of a twelfth aspect of the present disclosure comprises:

an arithmetic processing device mounted on a moving body; and

a server communicating with the arithmetic processing device via a network,

the arithmetic processing device comprising:

an input unit that accepts input information containing character strings and correction information containing one or more characters; and

a first communication unit communicating with the server via the network,

the server comprising:

a second communication unit communicating with the arithmetic processing device via the network;

a degree-of-similarity calculation unit that edits character strings of the input information using the one or more characters of the correction information, to calculate degrees of similarity between character strings of the input information; and

a correction processing unit that corrects a character string of the input information based on the degrees of similarity calculated by the degree-of-similarity calculation unit.

With such a configuration, the input information can be corrected easily.

Embodiments of the present disclosure will now be described with reference to the accompanying drawings. In the figures, elements are shown exaggerated for the purpose of easy explanation.

### First Embodiment

### [Input Device]

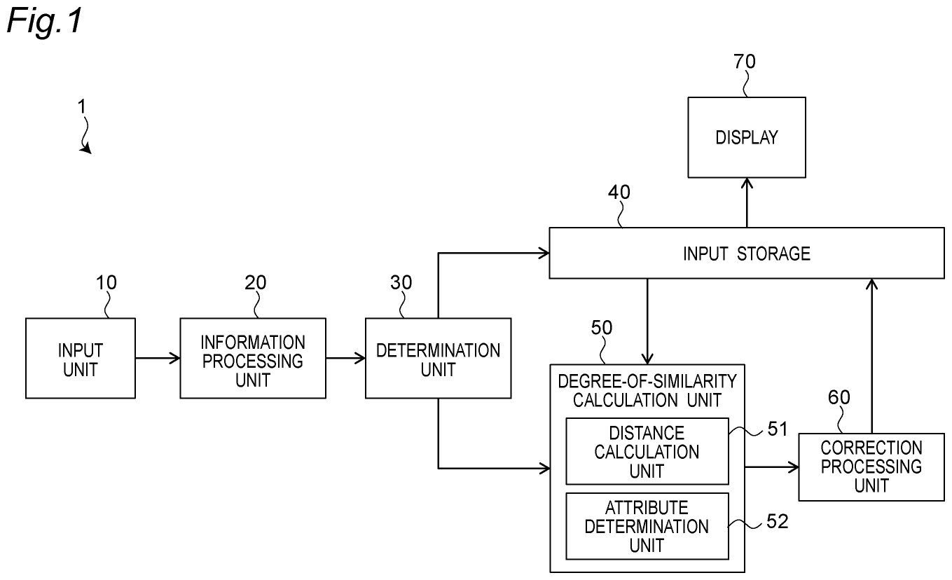

FIG. 1 is a block diagram showing an example of the configuration of an input device 1 of a first embodiment according to the present disclosure. The input device 1 shown in FIG. 1 is a device mounted on a moving body such as an automobile. The input device 1 is a device capable of accepting input information and correction information. In case that the input information is erroneously accepted, the input device 1 corrects the input information by accepting the correction information. In the first embodiment, the input information and the correction information are input by voice input.

The input information is information that is input to the input device 1 and includes character information to be recognized by the input device 1. The correction information is information for correcting the input information and includes character information for correcting character information included in the input information. In the first embodiment, the input information includes character information containing character strings on an automobile license plate. The character strings on the automobile license plate includes e.g. alphabets, numerals, and a place name. The correction information includes information of one or more characters used for the automobile license plate.

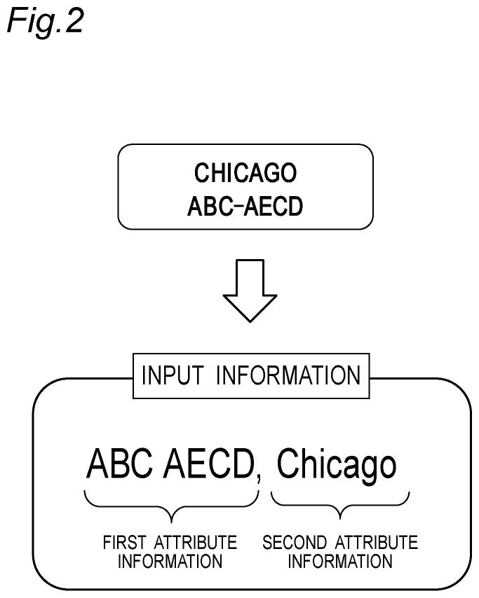

FIG. 2 is a schematic view showing an example of the input information. As shown in FIG. 2, the input information includes a plurality of character strings. In the example shown in FIG. 2, the input information includes a first character string in a number part indicative of seven alphabetical letters “ABC AECD” and a second character string in a place name part indicative of “Chicago”.

Further, the input information has a plurality of pieces of attribute information. Specifically, in the input information, attribute information is imparted to each of the plurality of character strings. In the example shown in FIG. 2, it has first attribute information and second attribute information. The first attribute information includes an attribute of the number part indicative of the seven alphabetical letters. The second attribute information includes an attribute of the place name. In the first embodiment, the first attribute information is assigned to the first character string of the input information, and the second attribute information is assigned to the second character string of the input information.

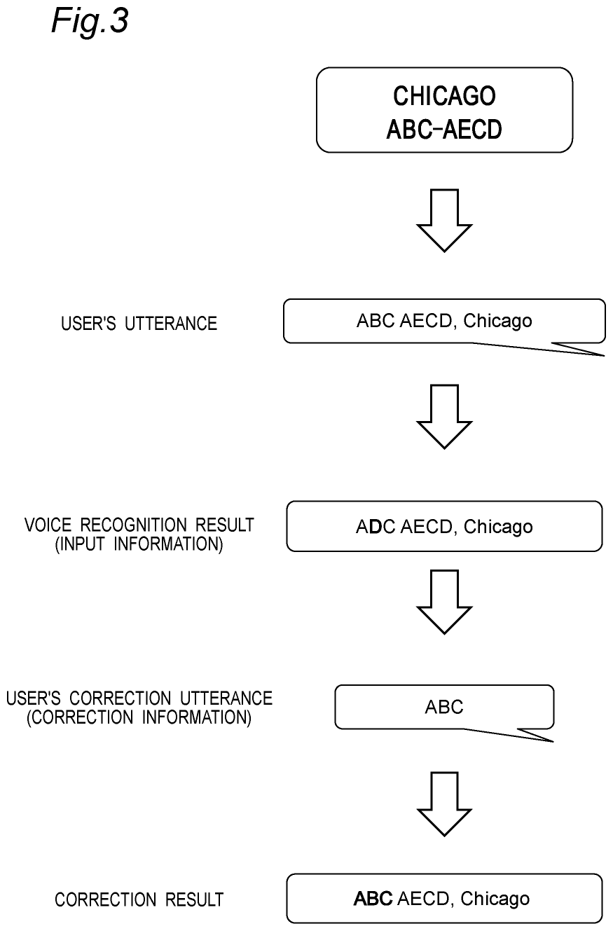

An example of correction of the input information by the input device 1 will then be briefly described with reference to FIG. 3. FIG. 3 is a schematic view showing an example of correction of the input information. As shown in FIG. 3, in order to input the automobile license plate character information into the input device 1, the user utters “ABC AECD, Chicago”. The input device 1 converts the user's voice information into text information to recognize the input information. At this time, the input device 1 may erroneously recognize the input information.

In the example shown in FIG. 3, the input device 1 erroneously recognizes the input information as “ADC ACED, Chicago”. To correct the input information, the user utters “ABC” to input correction information to the input device 1. The input device 1 corrects the input information based on the correction information. This enables the input information to be corrected to “ABC AECD, Chicago”.

In this manner, in the input device 1, the character strings of the input information can be corrected by inputting part of a character string to be corrected as correction information, instead of correcting all the character strings of the input information. Correction of the input information based on the correction information is performed based on the degree of similarity between the character strings. Detailed description of the degree-of-similarity-based correction will be given later.

The detailed configuration of the input device 1 will then be described. As shown in FIG. 1, the input device 1 comprises an input unit 10, an information processing unit 20, a determination unit 30, an input storage 40, a degree-of-similarity calculation unit 50, a correction processing unit 60, and a display 70.

### <Input Unit>

Input unit 10 accepts input information containing character strings and correction information containing one or more characters.

The input unit 10 comprises a voice input unit that accepts the input information and the correction information by voice for example. Examples of the voice input unit include a microphone. In the first embodiment, the input information and the correction information are input to the input unit 10 by voice input. That is, the input unit 10 accepts voice information indicative of the input information and voice information indicative of the correction information.

The voice information input to the input unit 10 is transmitted to the information processing unit 20.

### <Information Processing Unit>

The information processing unit 20 processes information input to the input unit 10. Specifically, the information processing unit 20 comprises a conversion unit that converts the voice information input to the input unit 10 into text information (character information). By converting the voice information into the text information (character information), the conversion unit acquires input information and correction information. An available algorithm converting voice information into character information can be e.g. various deep learning skills or methods utilizing Hidden Markov Model.

The information processed by the information processing unit 20 is transmitted to the determination unit 30.

### <Determination Unit>

The determination unit 30 determines whether the voice information input to the input unit 10 is input information or correction information. For example, the determination unit 30 counts the number of characters, based on the text information acquired in the information processing unit 20. If the number of characters is equal to or greater than a predetermined number, the determination unit 30 determines that the information input to the input unit 10 is the input information. If the number of characters is less than the predetermined number, the determination unit 30 determines that the information input to the input unit 10 is the correction information.

If determining that the information input to the input unit 10 is the input information, the determination unit 30 transmits the input information to the input storage 40. If determining that the information input to the input unit 10 is the correction information, the determination unit 30 transmits the correction information to the degree-of-similarity calculation unit 50.

### <Input Storage>

The input storage 40 is a storage medium that stores input information. The input storage 40 receives and stores the input information from the determination unit 30 and the correction processing unit 60. For example, the input storage 40 can be implemented by a hard disk (HDD), an SSD, a RAM, a DRAM, a ferroelectric memory, a flash memory, a magnetic disk, or a combination thereof.

### <Degree-of-Similarity Calculation Unit>

The degree-of-similarity calculation unit 50 edits character strings of the input information using one or more characters of correction information, to calculate degrees of similarity between character strings of the input information before and after editing. Specifically, the degree-of-similarity calculation unit 50 sets first to n-th characters of the input information as an edit start position and edits to change characters of the input information into characters of the correction information from the edit start position. The degree-of-similarity calculation unit 50 calculates the degree of similarity between character strings of the input information before and after editing. “n-th” is decided based on the number of characters of the input information and the number of characters of the correction information. For example, it is calculated from “n=(the number of characters of input information)-(the number of characters of correction information)”. That is, the degree-of-similarity calculation unit 50 edits character strings of the input information n times, to calculate the degree of similarity for each editing process.

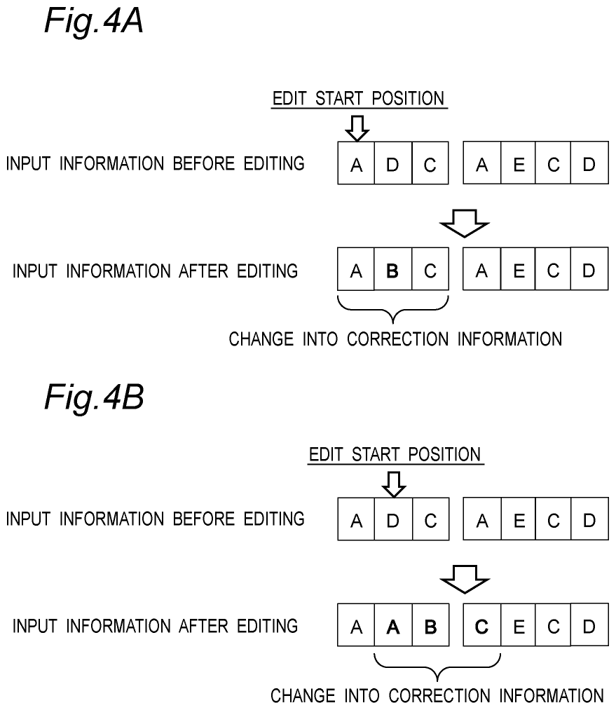

An example of calculation of the degree of similarity between character strings will be described with reference to FIGS. 4A and 4B. FIGS. 4A and 4B are schematic views explaining an example of calculation of the degree of similarity between character strings. The example of FIGS. 4A and 4B shows calculation of the degree of similarity performed when correction of FIG. 3 is performed. In other words, the example of FIGS. 4A and 4B shows calculation of the degree of similarity performed when correcting the erroneous input information “ADC AECD” into “ABC AECD” by input of the correction information “ABC”.

As shown in FIG. 4A, the degree-of-similarity calculation unit 50 edits the input information “ADC ACED” before editing. The degree-of-similarity calculation unit 50 sets the edit start position to the first character “A” of the input information. The degree-of-similarity calculation unit 50 starts editing from the position of the first character “A” of the input information. Specifically, the degree-of-similarity calculation unit 50 changes the first to third characters “ADC” of the input information into the correction information “ABC”. The degree-of-similarity calculation unit 50 calculates the degree of similarity between the input information “ADC AECD” before editing and the input information “ABC AECD” after editing.

The degree-of-similarity calculation unit 50 then sets the edit start position to the second character “D” of the input information. The degree-of-similarity calculation unit 50 starts editing from the second character “D” of the input information. As shown in FIG. 4B, the degree-of-similarity calculation unit 50 changes the second to fourth characters “DCA” of the input information into the correction information “ABC”. The degree-of-similarity calculation unit 50 calculates the degree of similarity between the input information “ADC AECD” before editing and the input information “AAB CECD” after editing.

In this manner, the degree-of-similarity calculation unit 50 edits character strings of the input information sequentially from the edit start position of the first to n-th characters of the input information using one or more characters of the correction information, to calculate respective degrees of similarity between character strings of the input information before and after editing.

Any algorithm may be adopted for a degree-of-similarity calculation method. For example, the degree-of-similarity calculation method may adopt algorithms calculating Levenshtein distance, Jaro-Winkler distance, etc.

In the first embodiment, the degree-of-similarity calculation unit 50 calculates a distance between character strings as the degree of similarity. In the distance between character strings, a smaller distance between character strings shows a higher degree of similarity therebetween, and a larger distance between character strings means a lower degree of similarity therebetween. An example of the configuration calculating the distance between character strings will hereinafter be described.

Referring back to FIG. 1, the degree-of-similarity calculation unit 50 includes a distance calculation unit 51 and an attribute determination unit 52.

The distance calculation unit 51 edits character strings of the input information using one or more characters of the correction information, to calculate distances between character strings of the input information before and after editing. Specifically, the distance calculation unit 51 carries out at least any one of editing processes of insert, delete, and replace on character strings of the input information, to thereby calculate the distances between character strings of the input information before and after editing. The distance calculation unit 51 acquires the input information before editing from the input storage 40.

As used herein, “delete” means deleting one character of the input information character string. “Insert” means inserting one character into the input information character string. “Replace” means replacing one character of the input information character string with another one.

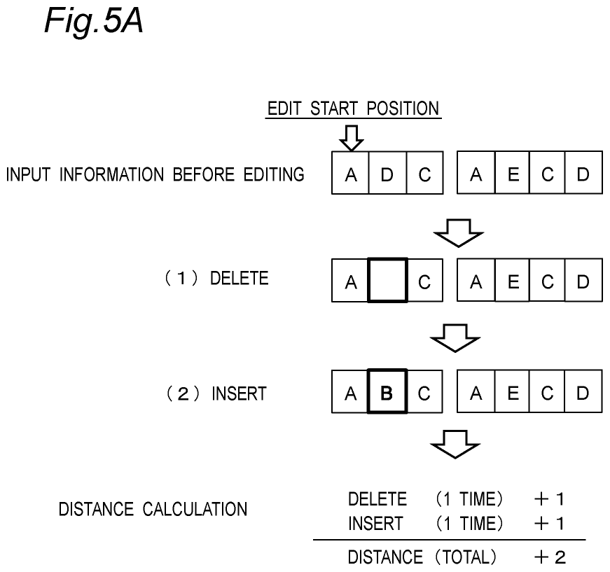

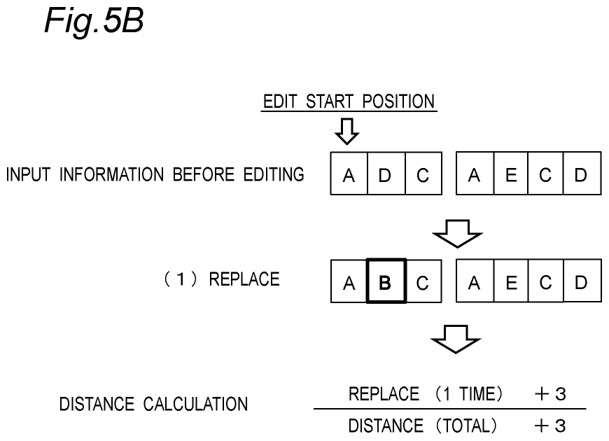

Referring to FIGS. 5A and 5B, examples of calculation of the distance by the distance calculation unit 51 will be described. FIGS. 5A and 5B are schematic views showing the examples of the distance calculation. Note that the examples shown in FIGS. 5A and 5B correspond to calculation of the degree of similarity shown in FIGS. 4A and 4B.

The examples shown in FIGS. 5A and 5B show calculations of the distance between character strings in the case of editing the input information “ADC AECD” before editing into the input information “ABC AECD” by input of the correction information “ABC”. Specifically, the distance calculation unit 51 sets the edit start position to the first character “A” of the input information. The distance calculation unit 51 starts editing from the position of the first character “A” of the input information. That is, the examples of FIGS. 5A and 5B show an example of calculation of the distance in the case of changing the first to third characters “ADC” of the input information into the correction information “ABC”.

The example shown in FIG. 5A will first be described. In the example of FIG. 5A, editing processes of the delete and the insert are performed on the character string of the input information, to thereby calculate the distances between character strings of the input information before and after editing.

In the case of changing the first to third characters “ADC” of the input information into the correction information “ABC”, the distance calculation unit 51 compares the characters of the correction information and the first to third characters of the input information, to identify the position of a character to be changed among the first to third characters of the input information. In the example of FIG. 5A, the second character “D” of the input information differs from the character “B” of the correction information. Thus, to change the second character “D” of the input information into the second character “B” of the correction information, the distance calculation unit 51 identifies the position of the second character “D”.

After identifying the position of the character to be changed, the distance calculation unit 51 edits the character at the identified position. For example, the distance calculation unit 51 deletes the second character “D” of the input information. The distance calculation unit 51 then inserts the second character “B” of the correction information into the deleted portion. In this manner, in the example of FIG. 5A, input information after editing can be obtained by effecting each of the delete and the insert once.

The distance calculation unit 51 calculates the distances between character strings of the input information before and after editing, based on the number of edits and the editing cost. For example, if the delete cost is “+1” with the insert cost of “+1”, the distance calculation unit 51 calculates the distance between character strings of the input information before and after editing to be “+2” since the delete and the insert are each performed once in the example shown in FIG. 5A.

The example shown in FIG. 5B will then be described. In the example of FIG. 5B, an editing process of the replace is performed on the input information character string, to thereby calculate the distance between character strings of the input information before and after editing.

In the example of FIG. 5B, similar to the example of FIG. 5A, in order to change the second character “D” of the input information into the second character “B” of the correction information, the distance calculation unit 51 identifies the position of the second character “D” of the input information.

After identifying the position of the character to be changed, the distance calculation unit 51 edits the character at the identified position. For example, the distance calculation unit 51 replaces the second character “D” of the input information with “B”. In this manner, in the example of FIG. 5B, the input information after editing can be obtained by effecting the replace once.

The distance calculation unit 51 calculates the distance between character strings of the input information before and after editing, based on the number of edits and the editing cost. For example, if the delete cost is “+3”, the distance calculation unit 51 calculates the distance between character strings of the input information before and after editing to be “+3” since the replace is performed once in the example shown in FIG. 5B.

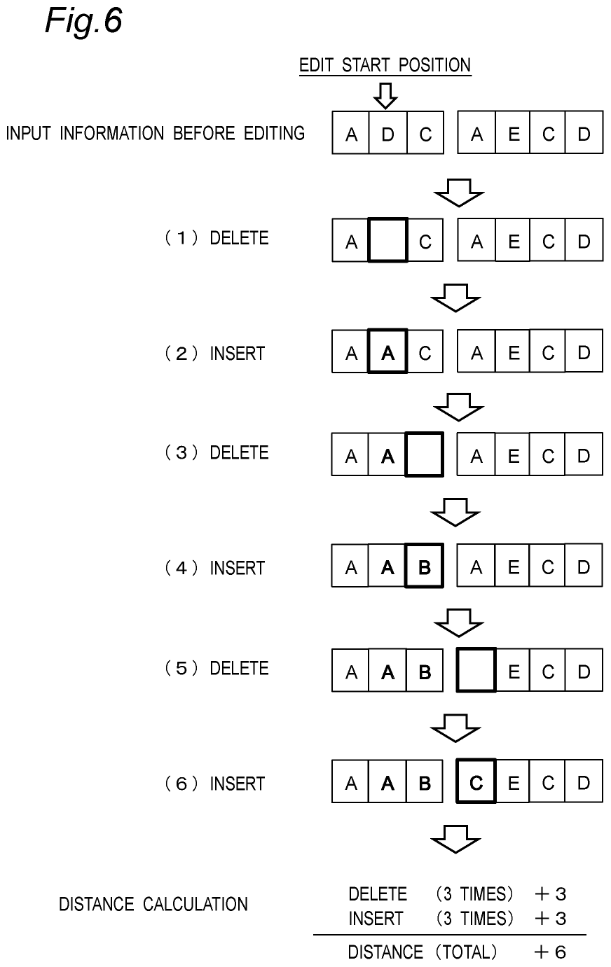

Referring next to FIG. 6, another example of calculation of the distance will be described. FIG. 6 is a schematic view showing another example of calculation of the distance. The example of FIG. 6 shows calculation of the distance between character strings in the case of editing the input information “ADC AECD” before editing into the input information “AAB CECD” by input of the correction information “ABC”. Specifically, the distance calculation unit 51 sets the edit start position to the second character “D” of the input information. The distance calculation unit 51 starts editing from the position of the second character “D” of the input information. That is, the example of FIG. 6 shows an example of calculation of the distance in the case of changing the second to fourth characters “DCA” of the input information into the correction information “ABC”. In the example of FIG. 6, the other conditions are the same as in the example of FIG. 5A.

In the case of changing the second to fourth characters “DCA” of the input information into the correction information “ABC”, the distance calculation unit 51 compares the characters of the correction information and the second to fourth characters of the input information, to identify the position of a character to be changed among the second to fourth characters of the input information. In the example of FIG. 6, all of the second to fourth characters of the input information differ from characters of the correction information. For this reason, the distance calculation unit 51 identifies the positions of the second to fourth characters “D”, “C”, and “A” of the input information.

After identifying the position of the character to be changed, the distance calculation unit 51 edits the character at the identified position. For example, the distance calculation unit 51 deletes the second character “D” of the input information, and then inserts the first character “A” of the correction information into the deleted portion. The distance calculation unit 51 deletes the third character “C” of the input information, and then inserts the second character “B” of the correction information into the deleted portion. Furthermore, the distance calculation unit 51 deletes the fourth character “A” of the input information, and then inserts the third character “C” of the correction information into the deleted portion. In this manner, in the example of FIG. 6, input information after editing can be obtained by effecting each of the delete and the insert three times.

In the example of FIG. 6, the distance calculation unit 51 calculates the distance between character strings of the input information before and after editing to be “+6” since the delete and the insert are each performed three times.

When comparing the example of FIG. 5A and the example of FIG. 6, the distance “+2” of the example of FIG. 5A is smaller than the distance “+6” shown in FIG. 6. From this, it can be seen that the example shown in FIG. 5A has a higher degree of similarity than the example shown in FIG. 6.

In this manner, the distance calculation unit 51 carries out at least any one of editing processes of the insert, delete, and replace on the input information character string, to thereby calculate the distance between character strings of the input information before and after editing. Note that the above numerical values of the editing cost of the delete, insert, and replace are mere exemplifications and that the present disclosure is not limited thereto. The editing cost may be set to any numerical value.

Information of the distances between character strings calculated by the distance calculation unit 51 is transmitted to the correction processing unit 60.

The attribute determination unit 52 determines into which attribute among a plurality of attributes the correction information is classified. For example, the attribute determination unit 52 receives correction information from the determination unit 30 and determines into which attribute between the first attribute information and the second attribute information of the input information shown in FIG. 2 the correction information is classified.

For example, if the character information of the correction information is one or more alphabetical letters, the attribute determination unit 52 recognizes that the correction information is information of the number part of an automobile. In this case, the attribute determination unit 52 determines that the correction information is the first attribute information. Alternatively, if the character information of the correction information is a place name, the attribute determination unit 52 recognizes that the correction information is information of the place name. In this case, the attribute determination unit 52 determines that the correction information is the second attribute information.

The attribute information determined by the attribute determination unit 52 is transmitted to the distance calculation unit 51. The distance calculation unit 51 determines which character string is to be edited among a plurality of character strings of the input information, based on the attribute information determined by the attribute determination unit 52. For example, if the correction information is classified into the first attribute information, the distance calculation unit 51 calculates the distance of the part of “ABC AECD” shown in FIG. 2 but does not calculate the distance of the part of “Chicago”. Alternatively, if the correction information is classified into the second attribute information, the distance calculation unit 51 calculates the distance of the part of “Chicago” shown in FIG. 2 but does not calculate the distance of the part of “ABC AECD”.

Rapid and smooth correction of input information becomes feasible by calculating the distance based on the attribute information in this manner.

### <Correction Processing Unit>

The correction processing unit 60 corrects an input information character string based on the degree of similarity calculated by the degree-of-similarity calculation unit 50. As described above, the degree-of-similarity calculation unit 50 edits character strings of the input information n time, to calculate a degree of similarity for each editing process. The correction processing unit 60 identifies an editing process having a highest degree of similarity from among a plurality of degrees of similarity calculated by the degree-of-similarity calculation unit 50. The correction processing unit 60 corrects the input information based on the editing process having the highest degree of similarity.

In the first embodiment, the correction processing unit 60 corrects an input information character string based on the distance between character strings calculated by the distance calculation unit 51. The correction processing unit 60 corrects an input information character string of a portion having a smallest distance among the distances between character strings calculated by the distance calculation unit 51. For example, when comparing the example of FIG. 5A and the example of FIG. 6, the distance “+2” of the example shown in FIG. 5A is smaller than the distance “+6” shown in FIG. 6. The correction processing unit 60 adopts the editing process shown in FIG. 5A and corrects the number part of the input information into “ABC AECD”.

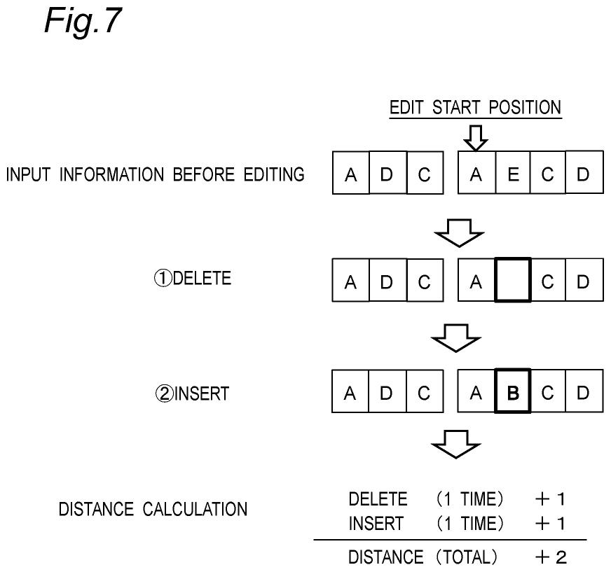

Processing will be described that is performed when there exist a plurality of editing processes having a highest degree of similarity among a plurality of degrees of similarity calculated by the degree-of-similarity calculation unit 50. Due to use of the distance between character strings as the degree of similarity in the first embodiment, description will be made using the distance between character strings. FIG. 7 is a schematic view showing another example of calculation of the distance. The example of FIG. 7 shows calculation of the distance between character strings in the case of editing the input information “ADC AECD” before editing into the input information “ADC ABCD” by input of the correction information “ABC”. Specifically, the distance calculation unit 51 sets the edit start position to the fourth character “A” of the input information. The distance calculation unit 51 starts editing from the fourth character “A” of the input information. That is, the example of FIG. 7 shows an example of calculation of the distance in the case of changing the fourth to sixth characters “AEC” of the input information into the correction information “ABC”. In the example of FIG. 7, the other conditions are the same as in the example of FIG. 5A.

In the example of FIG. 7, the distance calculation unit 51 deletes the fifth character “E” of the input information. The distance calculation unit 51 then inserts the second character “B” of the correction information into the deleted portion. In this manner, in the example of FIG. 7, input information after editing can be obtained by effecting each of the delete and the insert once.

Since the delete and the insert are each performed once in the example of FIG. 7, the distance calculation unit 51 calculates the distance between character strings of the input information before and after editing to be “+2”. When comparing the example of FIG. 5A and the example of FIG. 7, the both have the same distance “+2”. In this case, the correction processing unit 60 corrects a character of a first-calculated portion having a smallest distance in a character string of the input information. That is, the correction processing unit 60 adopts the editing process of the example shown in FIG. 5A and corrects the number part of the input information into “ABC AECD”.

In this manner, if there exist a plurality of portions having a smallest distance among a plurality of distances calculated by the distance calculation unit 51 in a character string of the input information, the correction processing unit 60 corrects a character of the first-calculated portion having a smallest distance. In other words, if there exist a plurality of portions having a highest degree of similarity among a plurality of degrees of similarity calculated by the degree-of-similarity calculation unit 50 in a character string of the input information, the correction processing unit 60 corrects a character of a first-calculated portion having a highest degree of similarity.

The input information corrected by the correction processing unit 60 is transmitted to the input storage 40.

### <Display>

The display 70 displays input information and corrected input information. The display 70 acquires the input information and the corrected input information from the input storage 40. The display 70 can be implemented by e.g. a display or a head-up display.

The elements making up the input device 1 can be implemented by e.g. a semiconductor element. The elements making up the input device 1 can be e.g. a microcomputer, a CPU, an MPU, a GPU, a DSP, an FPGA, or an ASIC. The functions of the elements making up the input device 1 may be implemented by hardware only or by combination of hardware and software.

The elements making up the input device 1 are collectively controlled by e.g. a controller. The controller comprises e.g. a memory storing programs and a processing circuit (not shown) corresponding to a processor such as a central processing unit (CPU). For example, in the controller, the processor executes a program stored in the memory. In the first embodiment, the controller controls the input unit 10, the information processing unit 20, the determination unit 30, the input storage 40, the degree-of-similarity calculation unit 50, the correction processing unit 60, and the display 70.

### [Input Method]

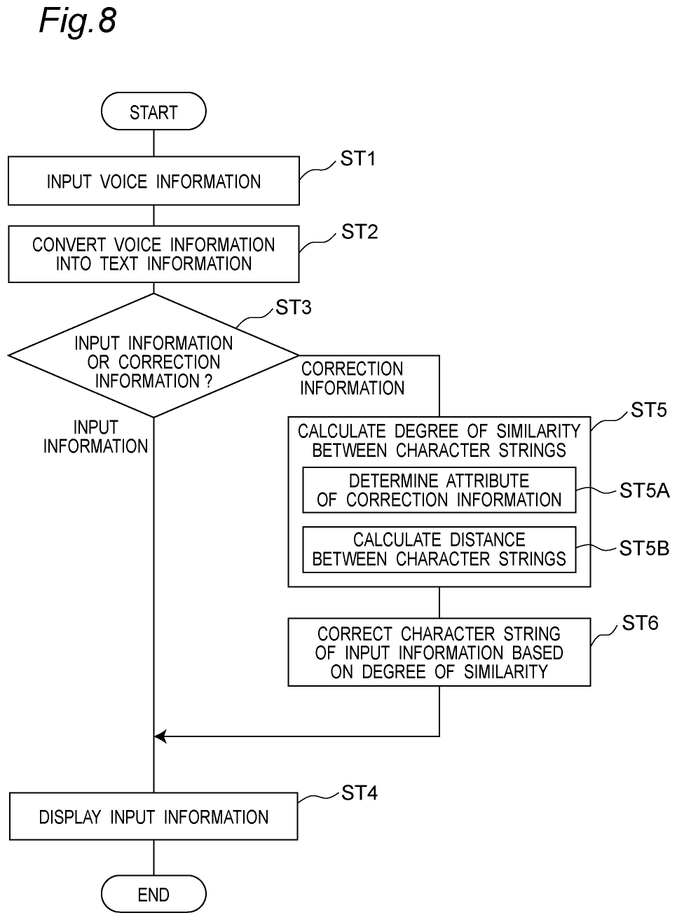

Referring to FIG. 8, an example of an input method of the first embodiment i.e. an example of the operation of the input device 1 will be described. FIG. 8 is a flowchart showing an example of the input method of the first embodiment according to the present disclosure. Steps ST1 to ST6 shown in FIG. 8 are carried out by the input device 1. The following is a detailed description thereof.

As shown in FIG. 8, at step ST1, voice information is accepted by the input unit 10. At step ST1, voice information is input to the input unit 10 by the user uttering.

The voice information input at step ST1 is used as input information or correction information. In the case of inputting the input information in the form of voice information, as in the example of FIG. 3, the user utters “ABC AECD, Chicago” toward the input unit 10. In the case of inputting the correction information in the form of voice information, as in the example of FIG. 3, the user utters “ABC” toward the input unit 10.

At step ST2, the voice information is converted into text information by the information processing unit 20. At Step ST2, the voice information input to the input unit 10 at step ST1 is converted into text information (character information). The input information and the correction information are hereby acquired. At this time, the information processing unit 20 may erroneously recognize and convert the voice information. For example, as in the example of FIG. 3, the voice information “ABC AECD, Chicago” input to the input unit 10 may be recognized as “ADC AECD, Chicago” and converted into text information.

At step ST3, it is determined by the determination unit 30 whether the information input to the input 10 is the input information or the correction information. Specifically, the determination unit 30 determines whether it is the input information or the correction information, based on the number of characters of the character information obtained by text conversion.

If at step ST3 the determination unit 30 determines that the information input to the input unit 10 is the input information, the process proceeds to step ST4. If the determination unit 30 determines that the information input to the input unit 10 is the correction information, the process proceeds to step ST5.

At step ST4, the input information is displayed by the display 70.

At step ST5, character strings of the input information are edited using one or more characters of the correction information by the degree-of-similarity calculation unit 50, to calculate the degrees of similarity between character strings of the input information before and after editing. In the first embodiment, at step ST5, the distances between character strings are calculated as the degrees of similarity between character strings.

Step ST5 includes step ST5A determining the attribute of the correction information and step ST5B calculating the distance between character strings.

At step ST5A, it is determined by the attribute determination unit 52 into which attribute among a plurality of attributes the correction information is classified. For example, at step ST5A, it is determined by the attribute determination unit 52 into which attribute between the first attribute information and the second attribute information shown in the example of FIG. 3 the correction information is classified.

At step ST5b, the distances between character strings are calculated by the distance calculation unit 51, based on the attributes of the input information and the correction information. For example, if the correction information is classified into the attribute of the first attribute information, at step ST5B the distance calculation unit 51 edits a portion of the first attribute information of the input information using one or more characters of the correction information, to calculate the distances between character strings of the input information before and after editing.

At step ST6, a character string of the input information is corrected by the correction processing unit 60, based on the degrees of similarity. Specifically, the correction processing unit 60 corrects an input information character string of a portion having a smallest distance among the distances between character strings calculated at step ST5B.

After correcting the input information at step ST6, the process proceeds to step ST4. As a result, the corrected input information is displayed by the display.

### [Another Example of Correction]

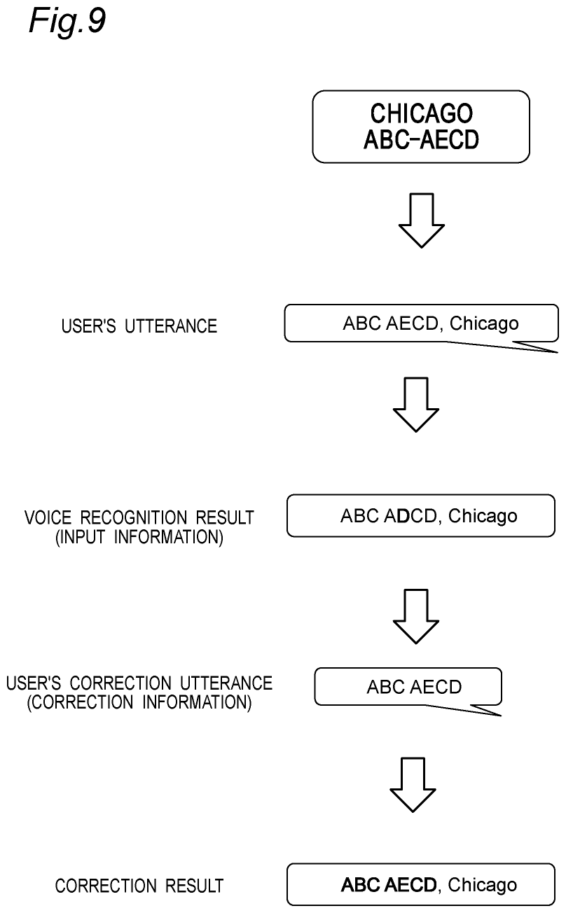

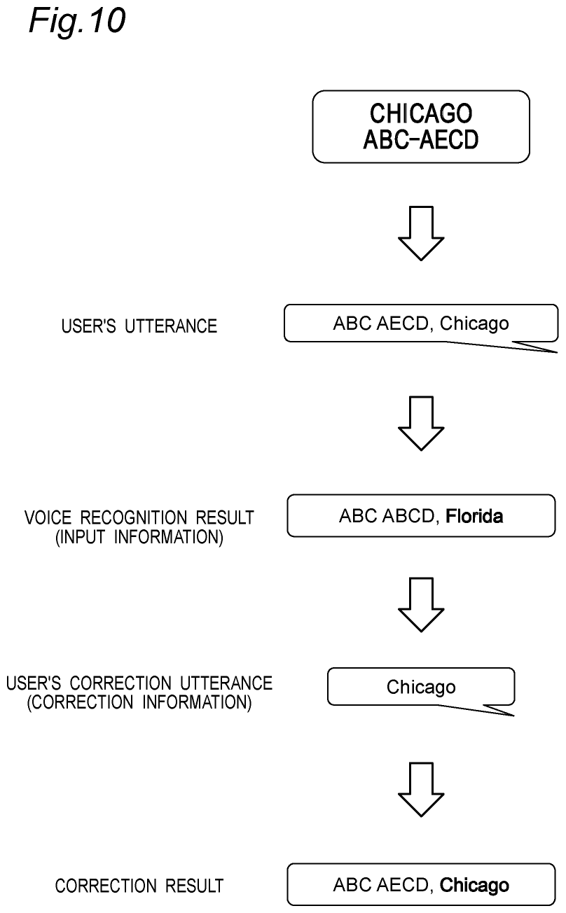

Referring to FIGS. 9 and 10, another example of correction of input information will next be described. FIGS. 9 and 10 are schematic views showing another example of correction of the input information.

The example shown in FIG. 9 will be described. In the example of FIG. 9, in order to input the automobile license plate character information to the input device 1, the user utters “ABC AECD, Chicago”. In the example of FIG. 9, the input device 1 erroneously recognizes the input information as being “ABC ADCD, Chicago”. That is, it erroneously recognizes the fifth character of the number part of the input information. In this case, in order to correct the input information, the user utters “ABC AECD” to input the correction information to the input device 1. The input device 1 corrects the input information based on the degree of similarity as described above, to thereby correct the input information into “ABC AECD, Chicago”.

The example shown in FIG. 10 will then be described. In the example of FIG. 10, in order to input the automobile license plate character information to the input device 1, the user utters “ABC AECD, Chicago”. In the example of FIG. 10, the input device 1 erroneously recognizes the input information as being “ABC AECD, Florida”. That is, it erroneously recognizes the place name part of the input information as “Florida”. In this case, in order to correct the input information, the user utters “Chicago” to input the correction information to the input device 1. The input device 1 corrects the input information based on the degree of similarity as described above, to thereby correct the input information into “ABC AECD, Chicago”. As for the place names, a plurality of place names are stored in advance in the input storage 40 so that a place name coincident with or similar to the place name input by the user is selected from among a plurality of place names.

### [Effects]

According to the input device 1 and the input method of the first embodiment, the following effects can be achieved.

The input device 1 is an input device mounted on a moving body and comprises the input unit 10, the information processing unit 20, the determination unit 30, the input storage 40, the degree-of-similarity calculation unit 50, the correction processing unit 60, and the display 70. The input unit 10 accepts input information containing a character string and correction information containing one or more characters through voice input. The information processing unit 20 converts the voice information input to the input unit 10 into text information. The determination unit 30 determines whether the voice information input to the input unit 10 is the input information or the correction information. The input storage 40 is a storage medium storing the input information. The degree-of-similarity calculation unit 50 edits character strings of the input information using one or more characters of the correction information, to calculate the degrees of similarity between character strings of the input information before and after editing. The correction processing unit 60 corrects a character string of the input information based on the degrees of similarity calculated by the degree-of-similarity calculation unit 50. The display 70 displays the input information and the corrected input information.

Such a configuration enables input information to be easily corrected even if the input information is erroneously accepted. Further, rapid and smooth correction of input information can be achieved by voice input even when the user is driving a moving body such as an automobile.

The degree-of-similarity calculation unit 50 includes the distance calculation unit 51 that edits character strings of the input information using one or more characters of the correction information, to calculate the degrees of similarity between character strings of the input information before and after editing. The correction processing unit 60 corrects the input information character string based on the distance between character strings calculated by the distance calculation unit 51.

With such a configuration, the degrees of similarity can be calculated based on the distances between character strings so that the input information can be corrected more easily. Further, the correction accuracy can be improved.

The distance calculation unit 51 carries out at least any one of editing processes of the insert, delete, and replace on character strings of the input information, to thereby calculate distances between character strings of the input information before and after editing. The distance calculation unit 51 acquires the input information before editing from the input storage 40.

With such a configuration, the input information can be corrected more easily. Further, the correction accuracy can be improved.

The correction processing unit 60 corrects an input information character string of a portion having a smallest distance among distances between character strings calculated by the distance calculation unit 51.

With such a configuration, the input information can be corrected more easily. Further, the correction accuracy can be more improved.

Input information has a plurality of attributes for classifying a plurality of character strings of the input information. The degree-of-similarity calculation unit 50 includes the attribute determination unit 52 that determines into which attribute among a plurality of attributes the correction information is classified. The degree-of-similarity calculation unit 50 calculates the degrees of similarity of the input information and the correction information.

Such a configuration enables the input information to be corrected more rapidly and smoothly.

The correction processing unit 60 corrects a character of a portion having a highest degree of similarity in a character string of the input information with the same attribute between the input information and the correction information.

With such a configuration, the input information can be corrected more easily. Further, the input information can be corrected more rapidly and smoothly.

If where there exist a plurality of portions having a highest degree of similarity among a plurality of degrees of similarity calculated by the degree-of-similarity calculation unit 50 in a character string of the input information, the correction processing unit 60 corrects a character of the first-calculated portion having a highest degree of similarity.

With such a configuration, the input information can be corrected more easily. Further, the input information can be corrected more rapidly and smoothly.

The input method of the first embodiment also has the same effect as the effect of the input device 1 described above.

In the first embodiment, the example has been described where the input information is the character string information of the automobile license plate, but the present disclosure is not limited thereto. Any input information is acceptable as long as it has character string information. For example, the input information may include character string information of an address, a place name, a person's name, a building name, a telephone number, etc.

In the first embodiment, the example has been described where the input information has a plurality of character strings, but the present disclosure is not limited thereto. For example, the input information may have one or more character strings.

In the first embodiment, the example has been described where the input information and the correction information have attribute information, but the present disclosure is not limited thereto. For example, the input information and the correction information may not have the attribute information.

In the first embodiment, the example has been described where the attribute information includes the first attribute information indicative of the number part of the automobile license plate and the second attribute information indicative of the place name, but the present disclosure is not limited thereto. The attribute information may be information indicative of an attribute. For example, the attribute information may be a code such as Alpha and Bravo.

Although in the first embodiment, FIGS. 3, 9 and 10 have been described as the examples of the correction information, the present disclosure is not limited thereto. The correction information is information for correcting input information and may include one or more pieces of character information that can be corrected based on the degree of similarity.

Although in the first embodiment, the example has been described where the input unit 10 comprises the voice input unit, the present disclosure is not limited thereto. The input unit 10 may allow input of input information and correction information. For example, the input unit 10 may comprise an input interface such as a touch panel or a keyboard. Alternatively, the input unit 10 may comprise an image acquisition unit. In this case, character information is acquired from image information obtained by the image acquisition unit.

Although in the first embodiment, the example has been described where the input device 1 comprises the information processing unit 20 and the determination unit 30, the present disclosure is not limited thereto. The information processing unit 20 and the determination unit 30 are not essential constituent elements. For example, in the case where information input to the input unit 10 is character information that is text information, the input device 1 may not comprise the information processing unit 20. Further, in the case where the input information and the correction information are acquired by respective different devices, the input device 1 may not comprise the determination unit 30.

Although in the first embodiment, the example has been described where the determination unit 30 determines the input information and the correction information based on the number of characters, the present disclosure is not limited thereto. For example, the determination unit 30 may determine the input information and the correction information based on the attribute information, etc.

In the first embodiment, the example has been described where the input device 1 comprises the input storage 40, but this is not limitative. The input storage 40 may not be an essential constituent element.

In the first embodiment, the distances between character strings calculated by the distance calculation unit 51 have been described as the example of the degrees of similarity of the degree-of-similarity calculation unit 50, but this is not limitative. The distance calculation unit 51 may not be an essential constituent element. The degree-of-similarity calculation unit 50 may be able to calculate the degrees of similarity between character strings. For example, algorithms calculating Levenshtein distance, Jaro-Winkler distance, etc. can be used as the algorithm for calculating the degree of similarity between character strings.

In the first embodiment, the example has been described where the degree-of-similarity calculation unit 50 comprises the attribute determination unit 52, but this is not limitative. The attribute determination unit 52 may not be an essential constituent element.

Although in the first embodiment, the example has been described where the input device 1 comprises the display 70, this is not limitative. The display 70 is not an essential constituent element. For example, the input device 1 may comprise a voice output unit audibly outputting the input information, in place of the display 70. Alternatively, the input device 1 may comprise both the display 70 and the voice output unit.

Although in the first embodiment, the example has been described where the input device 1 comprises the input unit 10, the information processing unit 20, the determination unit 30, the input storage 40, the degree-of-similarity calculation unit 50, the correction processing unit 60, and the display 70, this is not limitative. The elements making up the input device 1 may be increased or decreased. Alternatively, two or more elements of the plurality of elements making up the input device 1 may be integrated.

Although in the first embodiment, the example has been described where the input method includes steps ST1 to ST6, this is not limitative. The input method may include an increased or decreased number of steps or an integrated step. For example, if the input information and the correction information are input by different methods, the input method may not include step ST3. Alternatively, if the input information does not include the attribute information, the input method may not include step ST5A.

### Second Embodiment

An input device according to a second embodiment of the present disclosure will be described. In the second embodiment, differences from the first embodiment will mainly be described. In the second embodiment, the same or equivalent constituent elements as those in the first embodiment will be described with the same reference numerals. Further, in the second embodiment, descriptions overlapping with those of the first embodiment are omitted.

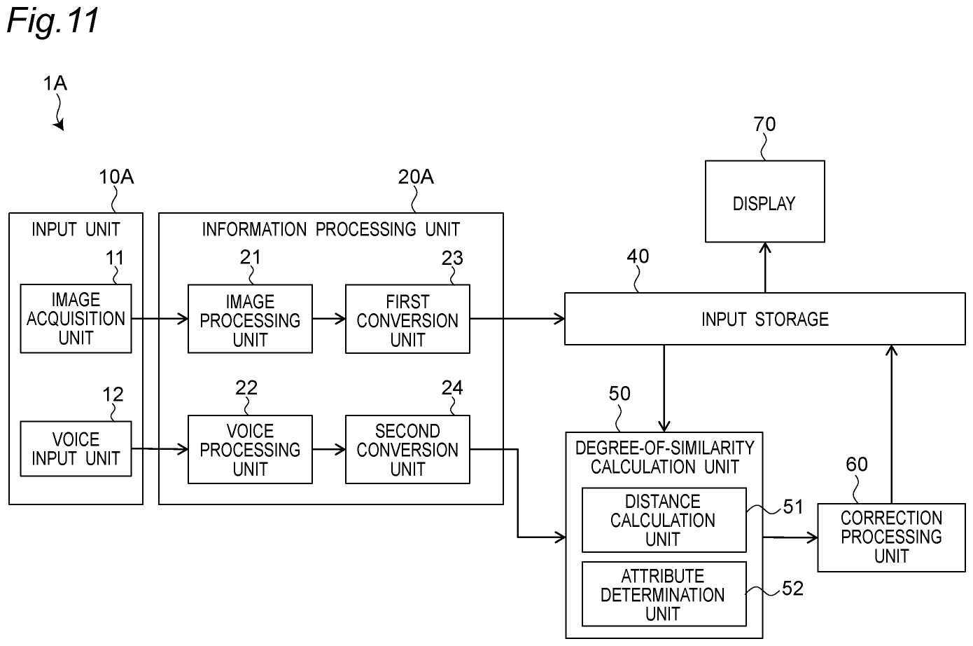

An example of the input device of the second embodiment will be described with reference to FIG. 11. FIG. 11 is a block diagram showing an example of the configuration of an input device 1A of the second embodiment according to the present disclosure.

The second embodiment differs from the first embodiment in that input information is acquired by an image acquisition unit 11 and that correction information is acquired by a voice input unit 12.

As shown in FIG. 11, the input device 1A comprises an input unit 10A, an information processing unit 20A, the input storage 40, the degree-of-similarity calculation unit 50, the correction processing unit 60, and the display 70. In the second embodiment, the input information is acquired based on image information, and the correction information is acquired based on voice information. This facilitates identification between the input information and the correction information, so that the input device 1A may not have the determination unit 30.

The input unit 10A includes the image acquisition unit 11 and the voice input unit 12.

The image acquisition unit 11 acquires image information. The image acquisition unit 11 is e.g. a camera that captures an image of a character string to be input. In the second embodiment, the image acquisition unit 11 acquires image information containing a character string written on a license plate of an automobile. For example, the image acquisition unit 11 acquires image information containing an automobile license plate written as “ABC AECD, Chicago”. The image information acquired by the image acquisition unit 11 is transmitted to the information processing unit 20A. The image information can be e.g. information such as a still image or a moving image.

The voice input unit 12 accepts voice information. The voice input unit 12 is e.g. a microphone that accepts user's voice information. For example, when the user utters “ABC” toward the voice input unit 12, the voice information is input to the voice input unit 12. The voice information input to the voice input unit 12 is transmitted to the information processing unit 20A.

In the second embodiment, the image acquisition unit 11 may be controlled by voice input to the voice input unit 12. For example, the user utters “Capture” as voice input toward the voice input unit 12. In response to this voice input as a trigger, the image acquisition unit 11 may acquire image information.

The information processing unit 20A converts the image information and the voice information acquired by the input unit 10A into text information (character information). The information processing unit 20A includes an image processing unit 21, a voice processing unit 22, a first conversion unit 23, and a second conversion unit 24.

The image processing unit 21 performs a process of extracting character string information from the image information acquired by the image acquisition unit 11. For example, if the image information includes license plates of a plurality of automobiles, the image processing unit 21 extracts character string information written on the license plate of an automobile selected by the user. The image information processed by the image processing unit 21 is transmitted to the first conversion unit 23.

The voice processing unit 22 performs a process of extracting character information from the voice information input to the voice input unit 12. For example, if the voice information contains noise, the voice processing unit 22 extracts information of one or more characters uttered by the user while filtering the noise. The voice information processed by the voice processing unit 22 is transmitted to the second conversion unit 24.

The first conversion unit 23 converts character string information contained in the image information processed by the image processing unit 21, into text information. As a result, input information is acquired. As an algorithm for converting image information into character string information, for example, a method using deep learning, simple pattern matching, or the like can be used.

The second conversion unit 24 converts information of one or more characters contained in the voice information processed by the voice processing unit 22, into text information. As a result, correction information is acquired.

Since the input storage 40, the degree-of-similarity calculation unit 50, the correction processing unit 60, and the display 70 in the first embodiment are the same as those in the first embodiment, description thereof will be omitted. In the second embodiment, the image information acquired by the image acquisition unit 11 and the image information processed by the image processing unit 21 may be transmitted to and displayed on the display 70.

The elements making up the input device 1A can be implemented by, e.g. the semiconductor element. The elements making up the input device 1 Can be e.g. the microcomputer, the CPU, the MPU, the GPU, the DSP, the FPGA, or the ASIC. The functions of the elements making up the input device 1 may be implemented by hardware only or by combination of hardware and software.

The elements making up the input device 1 are collectively controlled by e.g. the controller. The controller comprises e.g. the memory storing programs and the processing circuit (not shown) corresponding to the processor such as the central processing unit (CPU). For example, in the controller, the processor executes a program stored in the memory. In the second embodiment, the controller controls the input unit 10A, the information processing unit 20A, the input storage 40, the degree-of-similarity calculation unit 50, the correction processing unit 60, and the display 70.

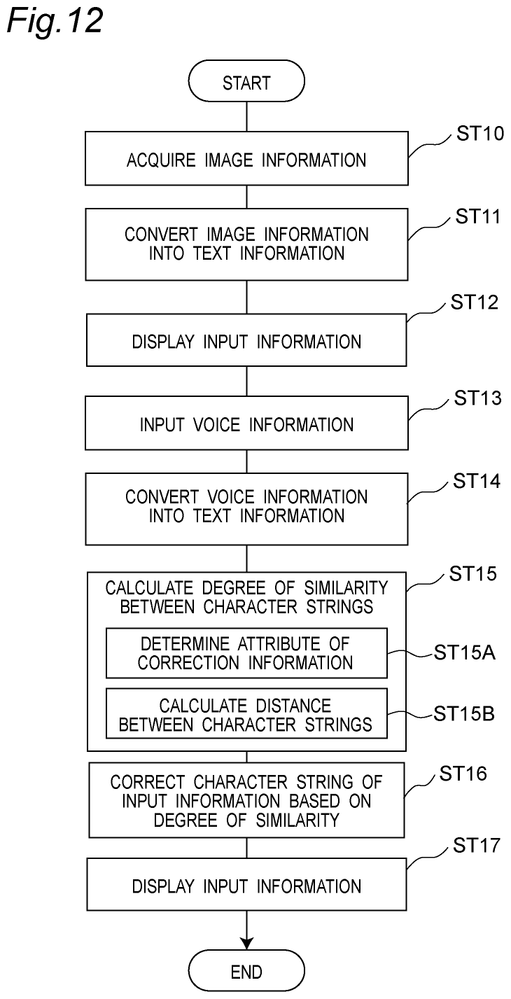

Referring to FIG. 12, an example of an input method of the second embodiment i.e. an example of the operation of the input device 1A will next be described. FIG. 12 is a flowchart showing an example of the input method of the second embodiment according to the present disclosure. Steps ST10 to ST17 shown in FIG. 12 are carried out by the input device 1A. The following is a detailed description thereof. Steps ST15 and ST16 shown in FIG. 12 are the same as steps ST5 and ST6 of the first embodiment.

As shown in FIG. 12, at step ST10, image information is acquired by the image acquisition unit 11. At step ST10, when the user utters “Capture” for example, the image acquisition unit 11 acquires image information containing character string information.

At step ST11, the character string information contained in the image information acquired by the image acquisition unit 11 is converted into text information (character information) by the image processing unit 21 and the first conversion unit 23. For example, if there exists character string information “ABC AECD, Chicago” in the image information, this character string information is converted into text information. Input information is thus acquired. At this time, similar to the example shown in FIG. 3, the input information may be erroneously recognized as “ADC AECD, Chicago”.

At step ST12, the input information is displayed by the display 70. At step ST12, the input information acquired based on the image information is displayed by the display 70. The user can confirm the input information displayed on the display 70. As a result, the user can confirm that the input information is erroneously accepted.

At step ST13, voice information is accepted by the voice input unit 12. At step ST13, when the user utters “ABC”, voice information is input to the voice input unit 12.

At step ST14, information of one or more characters contained in the voice information accepted by the voice input unit 12 is converted into text information by the voice processing unit 22 and the second conversion unit 24. Correction information is thus acquired.

At step ST15, character strings of the input information are edited using one or more characters of the correction information by the degree-of-similarity calculation unit 50, to calculate the degrees of similarity between character strings of the input information before and after editing.

Step ST15 includes step ST15A determining the attribute of the correction information and step ST15B calculating the distance between character strings. Since steps ST15A and ST15B are the same as steps ST5A and ST5B of the first embodiment, description thereof will be omitted.

At step ST16, the input information character string is corrected based on the degree of similarity by the correction processing unit 60.

At step ST17, the corrected input information is displayed by the display 70.

### [Example of Acquisition of Input Information]

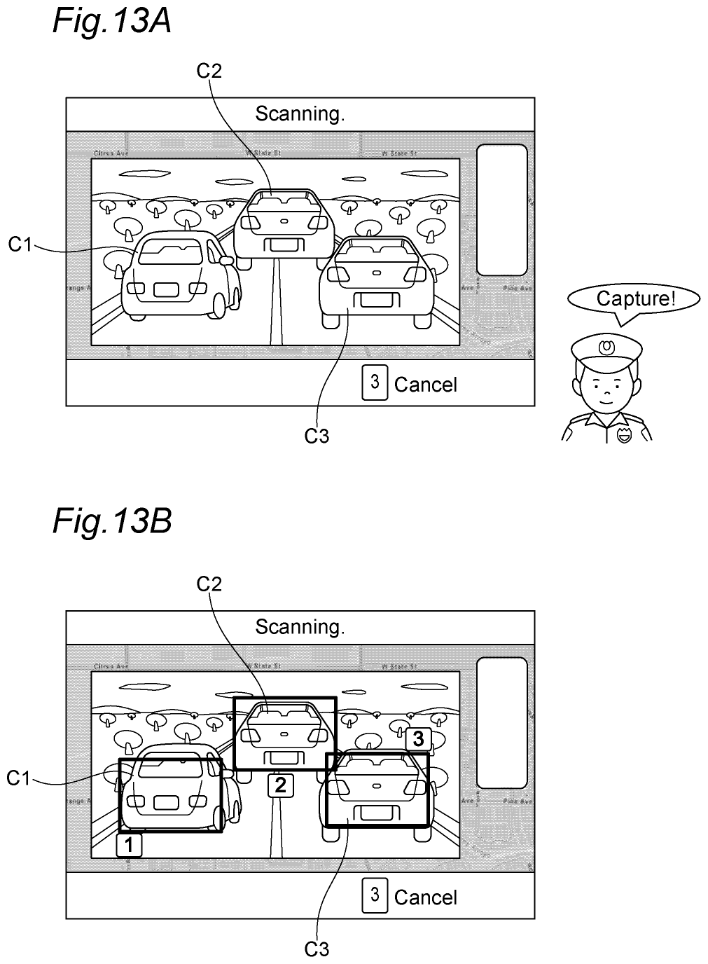

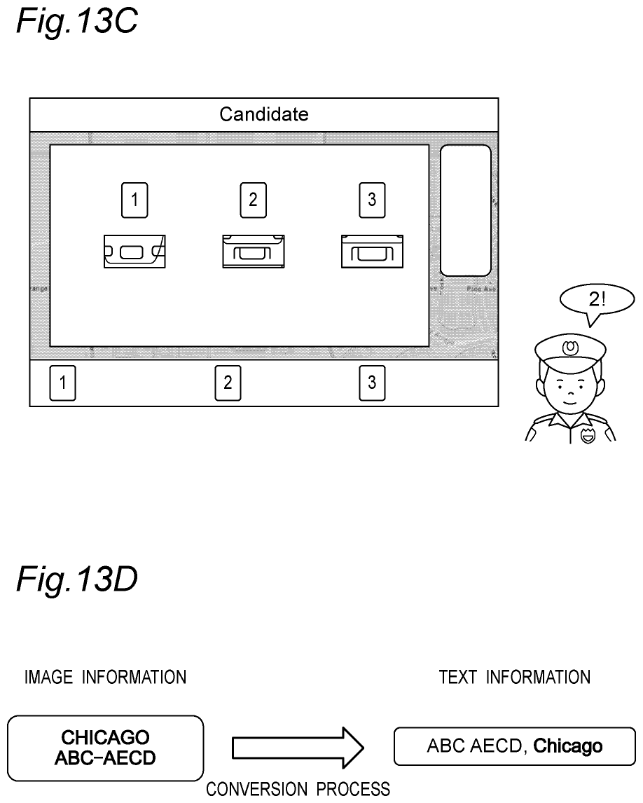

Referring to FIGS. 13A to 13D, an example of acquisition of input information in the second embodiment will be described. FIGS. 13A to 13D are schematic views explaining an example of acquisition of the input information. The example shown in FIGS. 13A to 13D shows screens displayed on the display 70 and is an example of acquiring the input information from image information containing plural pieces of character string information.

As shown in FIG. 13A, the user utters “Capture” toward the voice input unit 12. In response to this, the image acquisition unit 11 acquires image information. In the example shown in FIG. 13A, three automobiles C1, C2, and C3 are captured. The automobiles C1, C2, and C3 each have a license plate on which character string information is written. For this reason, three pieces of character string information are present in the image information acquired by the image acquisition unit 11. The image information acquired by the image acquisition unit 11 is transmitted to the image processing unit 21.

As shown in FIG. 13B, a screen selecting the automobile C1, C2, or C3 appears on the display 70. Specifically, the image processing unit 21 extracts three pieces of character string information of the automobiles C1, C2, and C3 from the image information acquired by the image acquisition unit 11 and assigns selection numbers “1”, “2”, and “3” to the automobiles C1, C2, and C3, respectively.

As shown in FIG. 13C, the image processing unit 21 allows the display 70 to display the selection numbers “1”, “2”, and “3” so as to correspond to the positions of the license plates of the automobiles C1, C2, and C3. For example, the display 70 displays image information of a cut-out license plate portion of the automobile C1 and the selection number “1”. The display 70 displays image information of a cut-out license plate portion of the automobile C2 and the selection number “2”. The display 70 displays image information of a cut-out license plate portion of the automobile C3 and the selection number “3”. By uttering a selection number toward the voice input unit 12, the user selects the selection number. For example, by uttering the selection number “2”, the user selects image information of the license plate portion of the automobile C2. The selected image information is transmitted to the first conversion unit 23.

As shown in FIG. 13D, the first conversion unit 23 converts the character string information contained in the image information into text information.

As in the examples of FIGS. 13A to 13D, in the image information containing plural pieces of character string information, one of the plural pieces of character string information is selected by the user so that input information can be acquired.

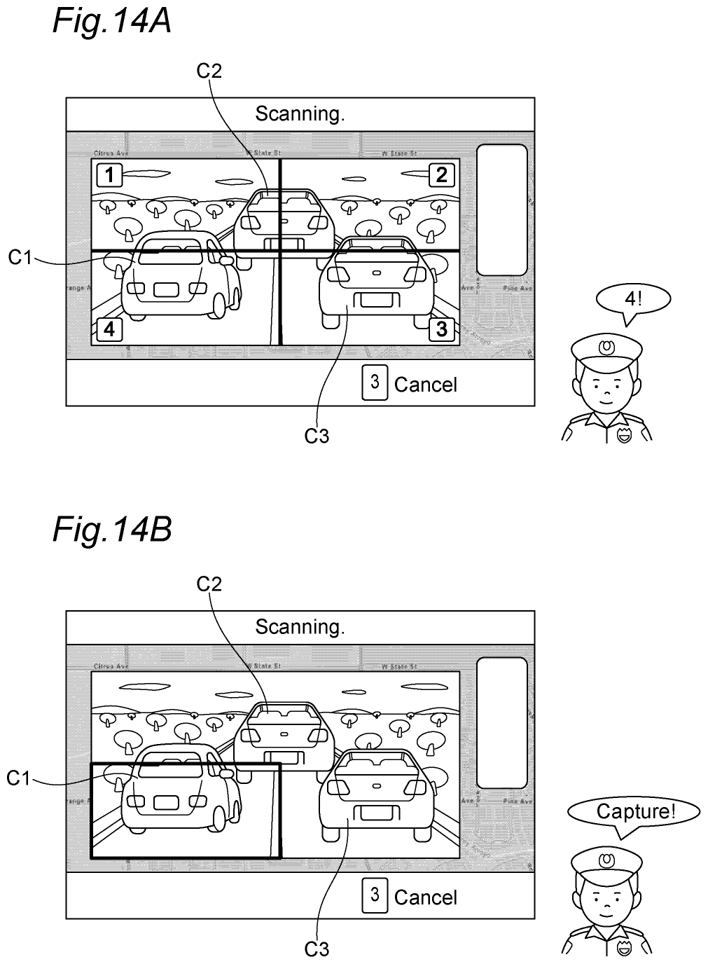

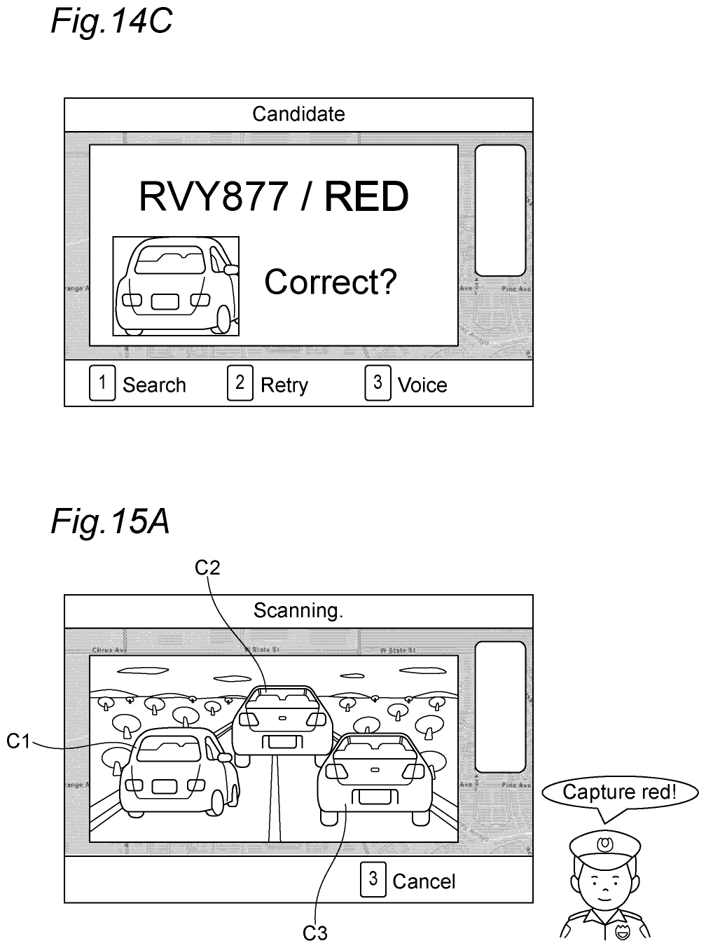

Referring to FIGS. 14A to 14C, another example of acquisition of input information in the second embodiment will be described. FIGS. 14A to 14C are schematic views explaining another example of acquisition of the input information. The example shown in FIGS. 14A to 14C shows a screen appearing on the display 70 and is an example of acquiring the input information from image information containing plural pieces of character string information.

As shown in FIG. 14A, image information appearing on the display 70 is divided into a plurality of areas. In the example of FIG. 4A, the image information is divided into four areas. For example, the image processing unit 21 divides the image information acquired by the image acquisition unit 11 into four areas i.e. upper left, upper right, lower left, and lower right areas. The image processing unit 21 assigns selection numbers “1”, “2”, “3”, and “4” to the upper left, upper right, lower right, and lower left areas, respectively. The user selects any one of the four areas. For example, in the case of wanting to acquire character string information of the license plate part of the automobile C1 as the input information, the user utters the selection number “4” toward the voice input unit 12.

As shown in FIG. 14B, in the image information appearing on the display 70, the area selected by the user is displayed in a highlighted manner. The user then utters “Capture” toward the voice input unit 12. The image acquisition unit 11 hereby acquires image information containing the license plate part of the automobile C1. The image information acquired by the image acquisition unit 11 is converted into text information (character information) by the first conversion unit 23. Input information is thus acquired.

As shown in FIG. 14C, the display 70 displays text information (character information) as input information and image information of the automobile C1. Further, the display 70 displays a message confirming whether or not the input information is incorrect. The user can hereby confirm the input information.

As in the example shown in FIGS. 14A to 14C, image information is divided into a plurality of areas so that one of the plurality of areas is selected by the user, whereby input information can be acquired from image information of the selected area.

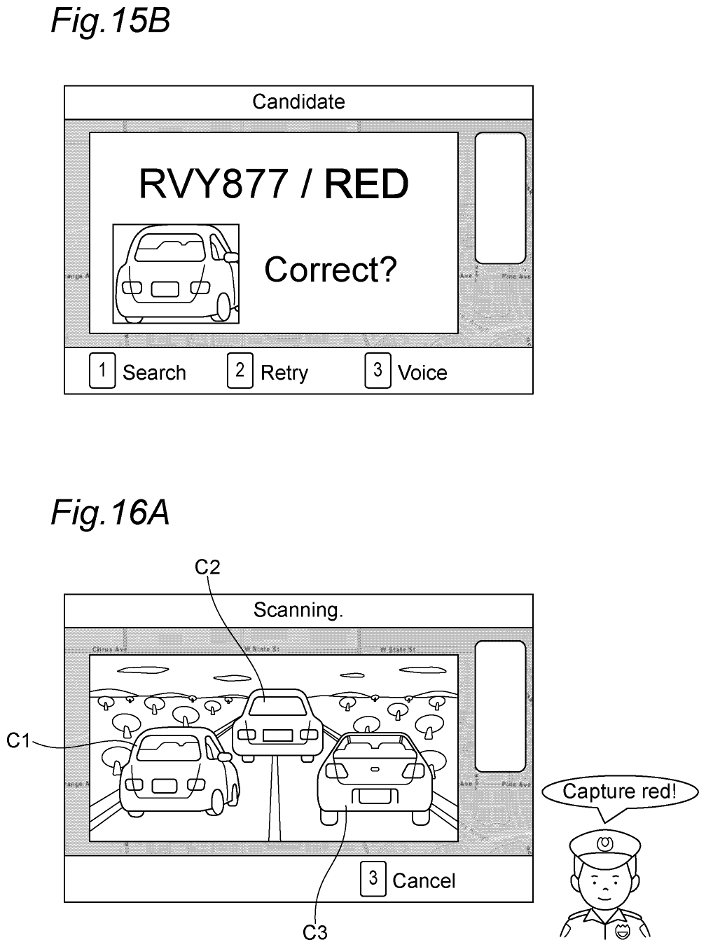

Referring to FIGS. 15A and 15B, another example of acquisition of input information in the second embodiment will be described. FIGS. 15A and 15B are schematic views explaining another example of acquisition of the input information. The example shown in FIGS. 15A and 15B shows a screen appearing on the display 70 and is an example of acquiring the input information from image information containing plural pieces of character string information. In the example shown in FIGS. 15A and 15B, the image information contains color information of the automobiles C1, C2, and C3. For example, the color of the automobile C1 is red, the color of the automobile C2 is gray, and the color of the automobile C3 is blue.

As shown in FIG. 15A, the user utters “Capture red” toward the voice input unit 12. In response to this, the image acquisition unit 11 acquires image information of the red automobile C1. For example, the image processing unit 21 identifies the colors of the automobiles C1, C2, and C3 from the image information acquired by the image acquisition unit 11. This allows the image acquisition unit 11 to acquire image information of an automobile with a color specified by the user, based on the user's voice information specifying the color input to the voice input unit 12.

As shown in FIG. 15B, the display 70 displays text information (character information) as input information, image information of the automobile C1, and information of color of the automobile C1. Further, the display 70 displays a message confirming whether or not the input information is incorrect. The user can hereby confirm the input information.

As in the example shown in FIGS. 15A and 15B, if the image information contains objects having a plurality of colors, the user specifies a color so that image information of an object having the specified color is acquired, whereupon input information can be acquired from the acquired image information.

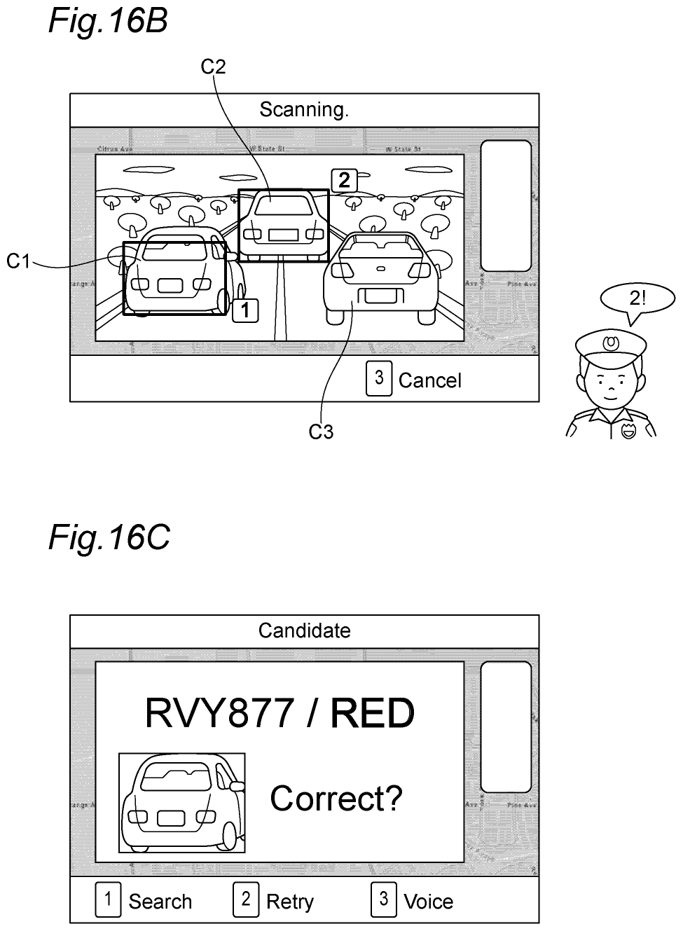

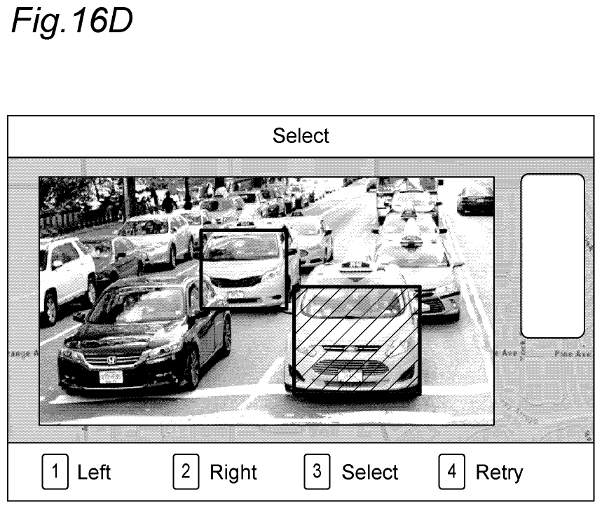

Referring to FIGS. 16A to 16D, yet another example of acquisition of input information in the second embodiment will be described. FIGS. 16A to 16D are schematic views explaining another example of acquisition of the input information. The example shown in FIGS. 16A to 16D shows a screen appearing on the display 70 and is an example of acquiring the input information from image information containing plural pieces of character string information. In the example shown in FIGS. 16A to 16D, the image information contains color information of the automobiles C1, C2, and C3. For example, the color of the automobiles C1 and C2 is red and the color of the automobile C3 is blue.

As shown in FIG. 16A, the user utters “Capture red” toward the voice input unit 12. The image processing unit 21 identifies the colors of the automobiles C1, C2, and C3 from the image information acquired by the image acquisition unit 11. In the example shown in FIG. 16A, the automobiles C1 and C2 are red in color.

For this reason, as shown in FIG. 16B, the image processing unit 21 assigns selection numbers “1” and “2” to the automobiles C1 and C2, respectively. The user utters a selection number toward the voice input unit 12 to thereby select the selection number. For example, the user utters the selection number “2” to thereby select the automobile C2. In response to this, the image acquisition unit 11 acquires image information of the automobile C2.

As shown in FIG. 16C, the display 70 displays text information (character information) as input information, image information of the automobile C2, and information of color of the automobile C2. Further, the display 70 displays a message confirming whether or not the input information is incorrect. This enables the user to confirm the input information.

In the example shown in FIG. 16D, in the case of the image information containing a plurality of automobiles with the same color, similar to FIG. 16B, an automobile selected by the user is shown in a highlighted manner. By displaying the automobile selected by the user in a rectangular frame in this manner, the user can easily confirm the selected automobile.

As in the example shown in FIGS. 16A to 16D, in the case of the image information containing a plurality of objects with the same color, the user specifies a color and a selection number so that image information of the specified object is acquired, whereupon input information can be acquired from the acquired image information.

### [Effects]

According to the input device 1A and the input method of the second embodiment, the following effects can be achieved.

In the input device 1A, the input information includes image information having a character string captured and the correction information includes voice information containing information of one or more characters. The input unit 10A includes the image acquisition unit 11 acquiring image information and the voice input unit 12 accepting voice information. The information processing unit 20A includes the first conversion unit 23 and the second conversion unit 24. The first conversion unit 23 converts character string information contained in the image information acquired by the image acquisition unit 11, into text information. The second conversion unit 24 converts information of one or more characters contained in the voice information input to the voice input unit 12, into text information.

With such a configuration, the input information can be corrected more easily. Further, by acquiring input information from image information and by accepting correction information in the form of voice information, rapid and smooth acquisition and correction of the input information can be achieved.

The input method of the second embodiment also presents the same effects as those of the input device 1A described above.

Although in the second embodiment, the example has been described where the information processing unit 20A comprises the image processing unit 21 and the voice processing unit 22, the present disclosure is not limited thereto. The image processing unit 21 and the voice processing unit 22 may not be essential constituent elements.

Although in the second embodiment, the example has been described where the input method includes steps ST10 to ST17, the present disclosure is not limited thereto. The input method may include an increased or decreased number of steps or an integrated step. For example, the input method may include a step of determining whether or not correction information is input. In this case, if the correction information is input, the process may proceed to steps ST14 to ST17. If the correction information is not input, the process may come to an end.

Although in the second embodiment, the examples of acquisition of the input information have been described with the examples shown in FIGS. 13A to 13D, FIGS. 14A to 14C, FIGS. 15A and 15B, and FIGS. 16A to 16D, the acquisition of the input information is not limited to these. In the second embodiment, input information may be acquired from image information.

### Third Embodiment

An input device according to a third embodiment of the present disclosure will be described. In the third embodiment, differences from the second embodiment will mainly be described. In the third embodiment, the same or equivalent constituent elements as those in the second embodiment will be described with the same reference numerals. Further, in the third embodiment, descriptions overlapping with those of the second embodiment are omitted.

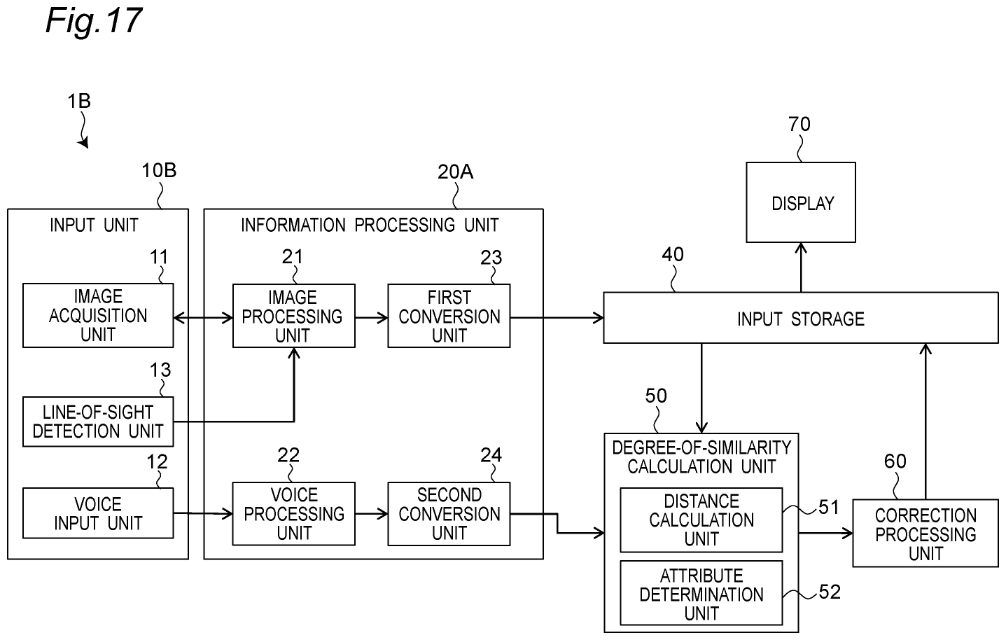

An example of the input device of the third embodiment will be described with reference to FIG. 17. FIG. 17 is a block diagram showing an example of the configuration of an input device 1B of the third embodiment according to the present disclosure.

The third embodiment differs from the second embodiment in comprising a line-of-sight detection unit 13.

As shown in FIG. 17, an input unit 10B of the input device 1B comprises the line-of-sight detection unit 13 in addition to the image acquisition unit 11 and the voice input unit 12.

The line-of-sight detection unit 13 detects the user's line of sight. The line-of-sight detection unit 13 is e.g. a camera that captures a user's face portion. Information of the user's line-of-sight detected by the line-of-sight detection unit 13 is transmitted to the image processing unit 21.

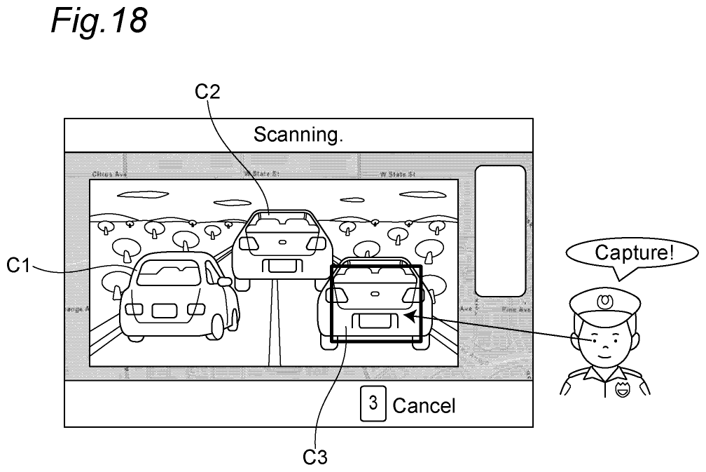

FIG. 18 is a schematic view explaining an example of acquisition of the input information. The example shown in FIG. 18 shows a screen appearing on the display 70 and is an example of acquiring the input information from image information containing plural pieces of character string information.

As shown in FIG. 18, the line-of-sight detection unit 13 detects the user's line of sight and detects which of the automobiles C1, C2, and C3 the user is looking at. The image processing unit 21 determines the automobile that the user is looking at, based on information of the user's line of sight detected by the line-of-sight detection unit 13. In the example shown in FIG. 15, the image processing unit 21 determines that the user is looking at the automobile C3.

The image processing unit 21 may display a rectangular frame for the automobile C3 determined to be looked at by the user. This enables the user to confirm the automobile being selected by the user's own line of sight.

When the user utters “Capture” toward the voice input unit 12, the image acquisition unit 11 acquires image information of the license plate portion of the automobile C3. The first conversion unit 23 converts character string information contained in the image information into text information.

In this manner, in the image information containing plural pieces of character string information, input information can be acquired by selecting one piece of character string information from among plural pieces of character string information in accordance with the user's line of sight, based on the user's line-of-sight information.

### [Effect]

According to the input device 1B of the third embodiment, the following effect can be achieved.

The input unit 10B of the input device 1B comprises the line-of-sight detection unit 13 in addition to the image acquisition unit 11 and the voice input unit 12. With such a configuration, the user's line-of-sight information can be acquired by the line-of-sight detection unit 13. Hereby, for example, in the image information containing plural pieces of character string information, input information can be acquired by selecting one piece of character string information from among plural pieces of character string information, based on the user's line-of-sight information. This results in rapid and smooth acquisition of input information.

### Fourth Embodiment

An input system according to a fourth embodiment of the present disclosure will be described. In the fourth embodiment, differences from the second embodiment will mainly be described. In the fourth embodiment, the same or equivalent constituent elements as those in the second embodiment will be described with the same reference numerals. Further, in the fourth embodiment, descriptions overlapping with those of the second embodiment are left out.

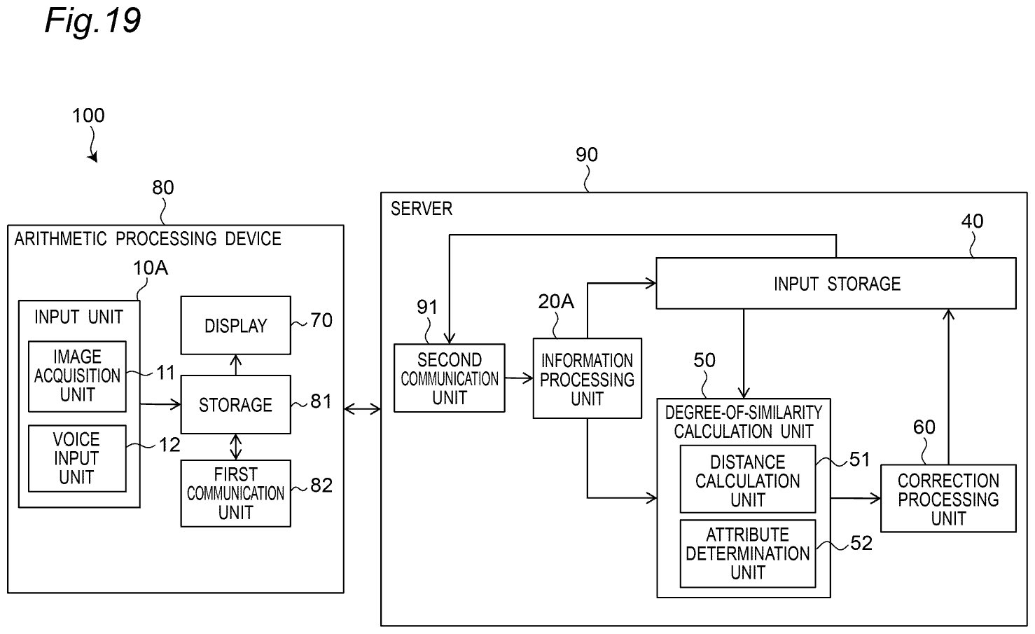

An example of the input system of the fourth embodiment will be described with reference to FIG. 19. FIG. 19 is a block diagram showing an example of the configuration of an input system 100 of the fourth embodiment according to the present disclosure.

As shown in FIG. 19, the input system 100 comprises an arithmetic processing device 80 mounted on a moving body and a server 90 that communicates with the arithmetic processing device 80 via a network.

### <Arithmetic Processing Unit>

The arithmetic processing device 80 acquires image information and voice information, for transmission to the server 90.

The arithmetic processing device 80 comprises the input unit 10A, the display 70, a storage 81, and a first communication unit 82. The input unit 10A and the display 70 are the same as those of the second embodiment and hence will not again be explained.

The storage 81 is a storage medium that stores information acquired by the input unit 10A and information received from the server 90. Specifically, the storage 81 stores image information acquired by the image acquisition unit 11, voice information accepted by the voice input unit 12, and information processed by the server 90.

The storage 81 can be implemented by a hard disk (HDD), an SSD, a RAM, a DRAM, a ferroelectric memory, a flash memory, a magnetic disk, or a combination thereof.

The first communication unit 82 communicates with the server 90 via a network. The first communication unit 82 includes a circuit that communicates with the server 90 in accordance with a predetermined communication standard. The predetermined communication standard includes e.g. LAN, Wi-Fi (registered trademark), Bluetooth (registered trademark), USB, HDMI (registered trademark), controller area network (CAN), and serial peripheral interface (SPI).

The arithmetic processing device 80 stores the image information and the voice information accepted by the input unit 10A, into the storage 81. By the first communication unit 82, the arithmetic processing device 80 transmits the image information and the voice information stored in the storage 81 to the server 90 via the network. By the first communication unit 82, the arithmetic processing device 80 receives input information from the server 90 via the network, for storage in the storage 81. The arithmetic processing device 80 displays the input information by the display 70.

The elements making up the arithmetic processing device 80 can be implemented by, e.g. the semiconductor element. The elements making up the arithmetic processing device 80 can be e.g. the microcomputer, the CPU, the MPU, the GPU, the DSP, the FPGA, or the ASIC. The functions of the elements making up the arithmetic processing device 80 may be implemented by hardware only or by combination of hardware and software.

The elements making up the arithmetic processing device 80 are collectively controlled by e.g. a first controller. The first controller comprises e.g. the memory storing programs and the processing circuit (not shown) corresponding to the processor such as the central processing unit (CPU). For example, in the first controller, the processor executes a program stored in the memory. In the fourth embodiment, the first controller controls the input unit 10A, the display 70, the storage 81, and the first communication unit 82.

### <Server>

The server 90 receives image information and voice information from the arithmetic processing device 80 and acquires input information and correction information based on the image information and the voice information. The server 90 corrects the input information obtained from the image information, based on the correction information obtained from the voice information.

The server 90 comprises the information processing unit 20A, the input storage 40, the degree-of-similarity calculation unit 50, the correction processing unit 60, and a second communication unit 91. The information processing unit 20A, the input storage 40, the degree-of-similarity calculation unit 50, and the correction processing unit 60 are the same as those of the second embodiment and hence will not again be explained.

The second communication unit 91 communicates with the arithmetic processing device 80 via the network. The second communication unit 91 includes a circuit that communicates with the arithmetic processing device 80 in accordance with a predetermined communication standard. The predetermined communication standard includes e.g. LAN, Wi-Fi (registered trademark), Bluetooth (registered trademark), USB, HDMI (registered trademark), controller area network (CAN), and serial peripheral interface (SPI).

By the second communication unit 91, the server 90 receives image information and voice information via the network from the arithmetic processing device 80. In the server 90, the received image information and voice information are transmitted to the information processing unit 20A.

The information processing unit 20A converts image information and voice information into text information to acquire input information and correction information. The input information is transmitted to the input storage 40 and is stored therein. The correction information is transmitted to the degree-of-similarity calculation unit 50. The degree-of-similarity calculation unit 50 edits character strings of the input information using one or more characters of the correction information, to calculate the degree of similarity between character strings of the input information before and after editing. The degree-of-similarity information is transmitted to the correction processing unit 60. The correction processing unit 60 corrects the input information character string based on the degree of similarity. The corrected input information is transmitted to the input storage 40 and stored therein.

By the second communication unit 91, the server 90 transmits the input information stored in the input storage 40 to the arithmetic processing device 80 via the network.

The elements making up the server 90 can be implemented by, e.g. the semiconductor element. The elements making up the server 90 can be e.g. the microcomputer, the CPU, the MPU, the GPU, the DSP, the FPGA, or the ASIC. The functions of the elements making up the server 90 may be implemented by hardware only or by combination of hardware and software.

The elements making up the server 90 are collectively controlled by e.g. a second controller. The second controller comprises e.g. the memory storing programs and the processing circuit (not shown) corresponding to the processor such as the central processing unit (CPU). For example, in the second controller, the processor executes a program stored in the memory. In the fourth embodiment, the second controller controls the information processing unit 20A, the input storage 40, the degree-of-similarity calculation unit 50, the correction processing unit 60, and the second communication unit 91.

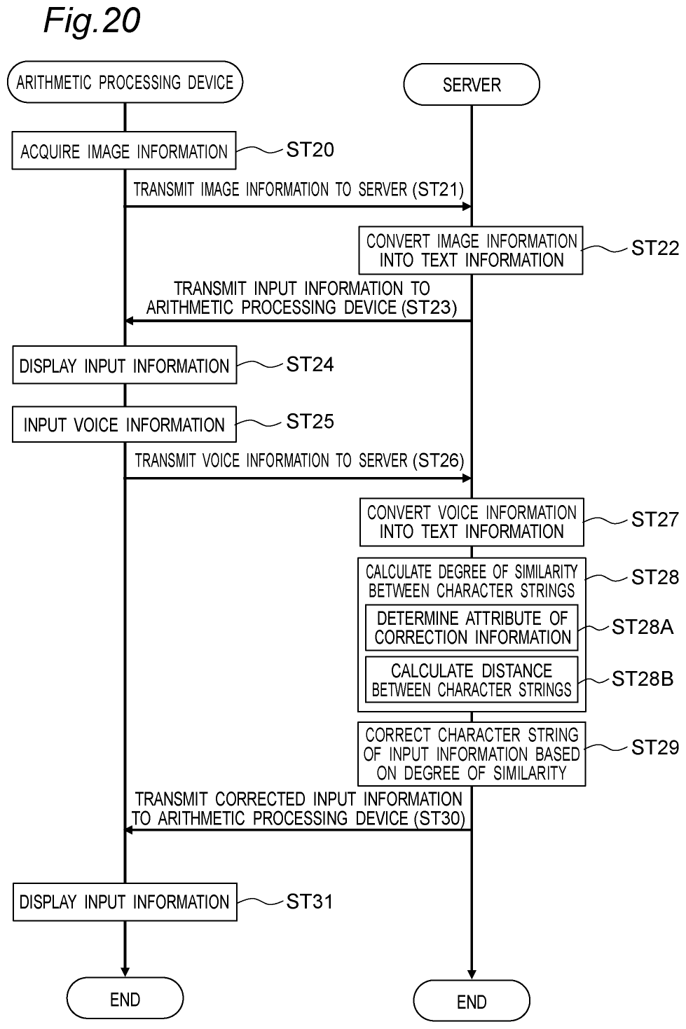

Referring to FIG. 20, an example of an input method of the fourth embodiment i.e. an example of the operation of the input system 100 will next be described. FIG. 20 is a flowchart showing an example of the input method of the fourth embodiment according to the present disclosure. Steps ST20 to ST31 shown in FIG. 20 are carried out by the input system 100. The following is a detailed description thereof. The steps ST20, ST22, ST24, ST25, ST27 to ST29, and ST31 shown in FIG. 20 are the same as the steps ST10 to ST17 of the second embodiment, respectively.

As shown in FIG. 20, at step ST20, image information is acquired by the image acquisition unit 11 of the arithmetic processing device 80. At step ST20, when the user utters “Capture” toward the voice input unit 12 for example, the image acquisition unit 11 acquires image information.

At step ST21, the image information is transmitted via the network to the server 90 by the first communication unit 82 of the arithmetic processing device 80. The server 90 receives the image information by the second communication unit 91.

At step ST22, character string information contained in the image information is converted into text information by the information processing unit 20A of the server 90. The input information is thus acquired.

At step ST23, the input information is transmitted via the network to the arithmetic processing device 80 by the second communication unit 91 of the server 90. The arithmetic processing device 80 receives the input information by the first communication unit 82.

At step ST24, the input information is displayed by the display 70 of the arithmetic processing device 80. This enables the user to confirm whether or not the input information is erroneously accepted.

At step ST25, voice information is accepted by the voice input unit 12 of the arithmetic processing device 80.

At step ST26, the voice information is transmitted via the network to the server 90 by the first communication unit 82 of the arithmetic processing device 80. The server 90 receives the voice information by the second communication unit 91.

At step ST27, information of one or more characters contained in the voice information is converted into text information by the information processing unit 20A of the server 90. The correction information is thus acquired.

At step ST28, character strings of the input information are edited using one or more characters of the correction information by the degree-of-similarity calculation unit 50 of the server 90, to calculate the degrees of similarity between character strings of the input information before and after editing.

Step ST28 includes the step ST28A of determining the attribute of the correction information and the step ST28B of calculating the distance between character strings. Steps ST28A and ST28B are the same as steps ST15A and ST15B of the second embodiment and hence the explanations thereof are omitted.

At step ST29, the input information character string is corrected based on the degree of similarity by the correction processing unit 60 of the server 90.

At step ST30, the corrected input information is transmitted via the network to the arithmetic processing device 80 by the second communication unit 91 of the server 90. The arithmetic processing device 80 receives the corrected input information by the first communication unit 82.

At step ST31, the corrected input information is displayed by the display 70 of the arithmetic processing device 80.

### [Effects]

According to the input system and the input method of the fourth embodiment, the following effects can be achieved.

The input system 100 comprises the arithmetic processing device 80 mounted on a moving body and the server 90 that communicates with the arithmetic processing device 80 via a network. The arithmetic processing device 80 comprises the input unit 10A, the display 70, the storage 81, and the first communication unit 82. The input unit 10A accepts image information and voice information. The display 70 displays input information. The storage 81 stores the image information, the voice information, and the input information. The first communication unit 82 communicates with the server 90 via the network. The server 90 includes the information processing unit 20A, the input storage 40, the degree-of-similarity calculation unit 50, the correction processing unit 60, and the second communication unit 91. The information processing unit 20 converts image information and voice information into text information. The input storage 40 stores input information. The degree-of-similarity calculation unit 50 edits character strings of the input information using one or more characters of the correction information and calculates the degrees of similarity between character strings of the input information before and after editing. The correction processing unit 60 corrects a character string of the input information based on the degrees of similarity calculated by the degree-of-similarity calculation unit 50.

Such a configuration enables input information to be corrected more easily. Further, by acquiring the input information as image information and by accepting the correction information as voice information, rapid and smooth acquisition and correlation of the input information can be achieved.

In the input system 100, the image information and the voice information acquired by the arithmetic processing device 80 are transmitted to the server 90 so that the server 90 corrects the input information based on these pieces of information. This achieves a reduction in processing load on the arithmetic processing device 80.

The input method of the fourth embodiment also presents the same effects as the effects of the input system 100 described above.

In the fourth embodiment, the example has been described where the input system 100 acquires the input information based on the image information and acquires the correction information based on the voice information, but the present disclosure is not limited thereto. The input system 100 may be able to acquire input information containing a character string and correction information containing one or more characters. The input information may be acquired based on e.g. voice information acquired by the voice input unit or character information acquired by the input interface. The correction information may also be acquired based on e.g. character information acquired by the input interface.

In the fourth embodiment, the example has been described where the input system comprises the arithmetic processing device 80 and the server 90, but the present disclosure is not limited thereto. The input system 100 may comprise equipment other than the arithmetic processing device 80 and the server 90. The input system 100 may comprise a plurality of arithmetic processing devices 80.

In the fourth embodiment, the example has been described where the arithmetic processing device 80 includes the input unit 10A, the display 70, the storage 81, and the first communication unit 82, but the present disclosure is not limited thereto. The display 70 and the storage 81 are not essential constituent elements. The elements making up the arithmetic processing device 80 may be increased or decreased. Alternatively, two or more elements of a plurality of elements making up the arithmetic processing device 80 may be integrated. For example, the arithmetic processing device 80 may include the information processing unit 20A.

Although in the fourth embodiment, the example has been described where the server 90 includes the information processing unit 20A, the input storage 40, the degree-of-similarity calculation unit 50, the correction processing unit 60, and the second communication unit 91, the present disclosure is not limited thereto. The information processing unit 20A and the input storage 40 are not essential constituent elements. The elements making up the server 90 may be increased or decreased. Alternatively, two or more of a plurality of elements making up the server 90 may be integrated.

Although in the fourth embodiment, the example has been described where the input method includes steps ST20 to ST31, the present disclosure is not limited thereto. The input method may include an increased or decreased number of steps or an integrated step. For example, the input method may include a step of determining whether or not the correction information is accepted. In this case, if the correction information is accepted, the process may proceed to steps ST25 to ST31. If the correction information is not accepted, the process may come to an end.

The input devices 1, 1A, and 1B of the first to third embodiments and the input system 100 of the fourth embodiment may carry out a learning process that learns a best correction by using, as teaching data, the input information and the correction information acquired based on information (e.g. image information and voice information) input to the input units 10, 10A, and 10B. By carrying out the learning process, the accuracy of correction of input information based on information input to the input units 10, 10A, and 10B can be improved. For example, the input devices 1, 1A, and 1B of the first to third embodiments and the input system 100 of the fourth embodiment may comprise a learning unit that learns using, as teaching data, the input information and the correction information acquired based on information (e.g. image information and voice information) input to the input units 10, 10A, and 10B. For example, the learning unit may execute machine learning in accordance with the neural network model.

Although in the first to fourth embodiments, the example has been described where the moving body is an automobile, the present disclosure is not limited thereto. The moving body may be e.g. a motorcycle, an airplane, or a ship.

The input devices 1, 1A, and 1B of the first to third embodiments and the input system 100 of the fourth embodiment are more beneficial in the case where the moving body is a police vehicle. Police vehicles may undergo correction of the input information in urgent situations. Compared to general vehicles, the police vehicles are in an environment where noise is liable to occur and are in situations where input information is likely to be erroneously recognized. Due to easy correction of the input information, the input devices 1, 1A, and 1B and the input system 100 are more beneficial when mounted on the police vehicles.

Although the present disclosure has been fully described in relation to the preferred embodiments with reference to the accompanying drawings, it will be obvious to those skilled in the art that various modifications and alterations are feasible. Such modifications and alterations should be construed as being encompassed within the scope of the present disclosure defined by the appended claims, without departing therefrom.

Because of enabling input information to be corrected easily, the present disclosure is useful for the input device mounted on a moving body such as an automobile.

1. An input device mounted on a moving body, comprising:
an input unit that accepts input information containing character strings and correction information containing one or more characters;
a degree-of-similarity calculation unit that edits character strings of the input information using the one or more characters of the correction information, to calculate degrees of similarity between character strings of the input information before and after editing; and
a correction processing unit that corrects a character string of the input information based on the degrees of similarity calculated by the degree-of-similarity calculation unit.

2. The input device of claim 1, wherein
the degree-of-similarity calculation unit comprises a distance calculation unit that edits character strings of the input information using the one or more characters of the correction information, to calculate distances between character strings of the input information before and after editing, and wherein
the correction processing unit corrects a character string of the input information based on the distances between character strings calculated by the distance calculation unit.

3. The input device of claim 2, wherein
the distance calculation unit carries out at least any one of editing processes of insert, delete, and replace on character strings of the input information, to thereby calculate the distances between character strings of the input information before and after editing.

4. The input device of claim 3, wherein
the correction processing unit corrects a character string of the input information of a portion having a smallest distance among the distances between character strings calculated by the distance calculation unit.

5. The input device of claim 1, wherein
the input information has a plurality of attributes for classifying a plurality of character strings of the input information, wherein
the degree-of-similarity calculation unit comprises an attribute determination unit that determines into which attribute among the plurality of attributes the correction information is classified, and wherein
the degree-of-similarity calculation unit calculates the degrees of similarity based on the attributes of the input information and of the input information.

6. The input device of claim 5, wherein
the correction processing unit corrects a character of a portion having a highest degree of similarity in the character strings of the input information with the same attribute between the input information and the correction information.

7. The input device of claim 1, wherein
if in the character strings of the input information there exist a plurality of portions having a highest degree of similarity among a plurality of degrees of similarity calculated by the degree-of-similarity calculation unit, the correction processing unit corrects a character of a first-calculated portion having a highest degree of similarity.

8. The input device of claim 1, further comprising:
a display that displays the input information and the input information corrected.

9. The input device of claim 1, wherein
the input unit comprises a voice input unit that accepts voice information indicative of the input information and voice information indicative of the correction information,
the input device further comprising:
a determination unit that determines whether the voice information accepted by the voice input unit is the input information or the correction information, wherein
if the determination unit determines that the voice information is the correction information, the degree-of-similarity calculation unit calculates the degrees of similarity.

10. The input device of claim 1, wherein
the input information includes image information having a character string captured, wherein
the correction information includes voice information containing information of one or more characters, and wherein
the input unit comprises an image acquisition unit acquiring the image information and a voice input unit accepting the voice information,
the input device further comprising:
a first conversion unit that converts character string information contained in the image information acquired by the image acquisition unit, into text information; and
a second conversion unit that converts information of one or more characters contained in the voice information accepted by the voice input unit, into text information.

11. An input method which is performed on a moving body, comprising:
accepting input information containing character strings;
accepting correction information containing one or more characters;
editing character strings of the input information using the one or more characters of the correction information, to calculate degrees of similarity between character strings of the input information before and after editing; and
correcting a character string of the input information based on the degrees of similarity calculated.

12. An input system comprising:
an arithmetic processing device mounted on a moving body; and
a server communicating with the arithmetic processing device via a network,
the arithmetic processing device comprising:
an input unit that accepts input information containing character strings and correction information containing one or more characters; and
a first communication unit communicating with the server via the network,
the server comprising:
a second communication unit communicating with the arithmetic processing device via the network;
a degree-of-similarity calculation unit that edits character strings of the input information using the one or more characters of the correction information, to calculate degrees of similarity between character strings of the input information; and
a correction processing unit that corrects a character string of the input information based on the degrees of similarity calculated by the degree-of-similarity calculation unit.

13. The input system of claim 12, wherein
the degree-of-similarity calculation unit comprises a distance calculation unit that edits character strings of the input information using the one or more characters of the correction information, to calculate distances between character strings of the input information before and after editing, and wherein
the correction processing unit corrects a character string of the input information based on the distances between character strings calculated by the distance calculation unit.

14. The input system of claim 13, wherein
the distance calculation unit carries out at least any one of editing processes of insert, delete, and replace on character strings of the input information, to thereby calculate the distances between character strings of the input information before and after editing.

15. The input system of claim 14, wherein
the correction processing unit corrects a character string of the input information of a portion having a smallest distance among the distances between character strings calculated by the distance calculation unit.

16. The input system of claim 12, wherein
the input information has a plurality of attributes for classifying a plurality of character strings of the input information, wherein
the degree-of-similarity calculation unit comprises an attribute determination unit that determines into which attribute among the plurality of attributes the correction information is classified, and wherein
the degree-of-similarity calculation unit calculates the degrees of similarity based on the attributes of the input information and of the input information.

17. The input system of claim 16, wherein
the correction processing unit corrects a character of a portion having a highest degree of similarity in the character strings of the input information with the same attribute between the input information and the correction information.

18. The input system of claim 12, wherein
if in the character strings of the input information there exist a plurality of portions having a highest degree of similarity among a plurality of degrees of similarity calculated by the degree-of-similarity calculation unit, the correction processing unit corrects a character of a first-calculated portion having a highest degree of similarity.

19. The input system of claim 12, further comprising:
a display that displays the input information and the input information corrected.

20. The input system of claim 12, wherein
the input unit comprises a voice input unit that accepts voice information indicative of the input information and voice information indicative of the correction information,
the server further comprising:
a determination unit that determines whether the voice information accepted by the voice input unit is the input information or the correction information, wherein
if the determination unit determines that the voice information is the correction information, the degree-of-similarity calculation unit calculates the degrees of similarity.
